(19) United States
(12) Patent Application Publication
(10) Pub. No.: US 2024/0188588 A1
(43) Pub. Date: Jun. 13, 2024

(54) Ruminant Feed Supplement Formulations and Methods for Reducing Enteric Methane

(71) Applicant: Alga Biosciences Inc., Berkeley, CA (US)

(72) Inventors: Alexander Carter Brown, San Francisco, CA (US); Caroline Anne McKeon, Berkeley, CA (US); Daria Alexandra Balatsky, Berkeley, CA (US)

(21) Appl. No.: 18/433,105

(22) Filed: Feb. 5, 2024

Related U.S. Application Data
(63) Continuation of application No. PCT/US2022/039752, filed on Aug. 8, 2022.
(60) Provisional application No. 63/230,581, filed on Aug. 6, 2021.

(51) Int. Cl. A23K 10/16; A23K 20/10; A23K 20/163; A23K 50/10

(52) U.S. Cl. CPC A23K 10/16; A23K 20/10; A23K 20/163; A23K 50/10

(57) ABSTRACT

The present disclosure provides novel compositions for the reduction of enteric methane and methods for supplementing animal feed that result in significant reduction in methane emissions in ruminants supplemented with compositions of the present invention.

### 1. PRIORITY

This application claims the benefit under 35 U.S.C. § 365(c) of International Patent Application No. PCT/US2022/039752, filed 9 Feb. 2023, which claims priority to U.S. Provisional Application No. 63/230,581, filed 6 Aug. 2021, which are hereby incorporated by reference.

### 2. TECHNICAL FIELD

The present invention relates to animal feed compositions and methods of administering the compositions to significantly reduce methane emission and/or for improving the metabolic efficiency of ruminant animals.

### 3. BACKGROUND

Enteric fermentation is the highly evolved process that allows ruminants to digest cellulose, the basic component of plant cell walls. Rumen microbes ferment simple and complex carbohydrates like cellulose to produce volatile fatty acids (VFAs), which can satisfy over 70% of the energy requirements of the host animal. However, the production of certain VFAs also produces hydrogen (H₂), which is converted to methane (CH₄) by methanogenic archaea (i.e., methanogens). Ruminant methane production from carbon represents a loss of energy, from 2 to 12% of gross energy intake from feed.

Although CH₄ is short-lived relative to other greenhouse gases (GHG), persisting in the atmosphere for about 10 years, it has a significant impact on the climate due to its global warming potential (GWP), which is ˜28-times higher than that of carbon dioxide (CO₂) as it is significantly more effective in trapping heat. Methane is the second-most abundant greenhouse gas after carbon dioxide (CO₂). Methane's short lifespan means that taking steps now to significantly reduce methane is expected to have a significant impact within our lifetimes.

Agriculture contributes around 40-46% of global methane emissions, and because of rising food production, these emissions are on a path to increase roughly 40% by 2050. Of these emissions, two-thirds are from methanogenesis from livestock, primarily cattle, buffalo, sheep, and goats and mostly released by eructation (in contrast to manure).

Numerous approaches for mitigating enteric methane emissions have been proposed and investigated over the last several decades, including rumen manipulation through feed supplements that indirectly or directly inhibit methanogenesis including administering seaweeds containing halogenated compounds.

U.S. Patent Application 2019/0174793, Growth performance improvements in pasture and feedlot systems, incorporated herein by reference, discloses a method for improving the growth performance of a livestock animal in various farming systems, including providing a red marine macroalgae to the farming systems to enable consumption of the red marine macroalgae.

U.S. Patent Application 2019/0174793 describes a formulation such that the animal is provided with of red marine macroalgae per day for animals maintained at pasture and states that amounts to about 1-5% of algae on a dry matter basis or 1-3% on an organic matter basis per day. US Patent Application 2019/0174793 also discloses providing an animal with about 200-600 g/day of algae for animals on a finishing diet in feedlots. In one example, this application discloses the filamentous tetrasporophyte life stage of Asparagopsis as a potential feedstock for a feed premix.

However, additional factors limit the potential of Asparagopsis taxiformis (AT) as a feed supplement in an amount sufficient to significantly inhibit methanogenesis in ruminant animals such as its unpleasant odor and taste, high iodine content, epiphytic nature, the lack of capacity, especially in male AT specimens, to synthesize material concentrations of the halogenated compounds and the overall inconsistency of the concentrations of bromoform and other halogenated compounds present in Asparagopsis taxiformis and other red algae which have been shown to vary widely based on the growth environment, seasonality, species, strain, life stage, cultivation method, and other known and unknown factors.

The poor palatability of seaweed is evidenced by reports that cows regularly refused seaweed or selected against it when mixed with their fresh feed, (Muizelaar et al., 2021). Roque et al., 2021 reports that seaweed fed at higher levels in the diet has led to a reduced dry matter intake in beef. Similar reports have issued regarding dairy cows (Roque et al., 2019, Stefenoni et al., 2021, Muizelaar et al., 2021). A lower feed intake is particularly problematic as this may also lead to lower performance as shown by reduced milk yield when cows are fed high dosage levels of seaweed (Roque et al., 2019, Stefenoni et al., 2021, Muizelaar et al., 2021).

Seaweed is also known to contain high iodine levels (Makkar et al., 2016) and its transfer to livestock products has been studied. Feeding seaweed (Asparagopsis taxiformis) at 0.25% and 0.5% inclusion level in the diet to beef cattle resulted in a daily intake of iodine of 106 to 225 mg/day of iodine (Roque et al., 2021). This exceeds the recommended daily iodine intake levels of around 5 mg/day based on 0.5 mg/kg DMI (NRC, 2006) and 10 kg DM intake in this study. The transfer of iodine in milk is of a larger concern. Feeding Asparagopsis taxiformis at 0.5% in the diet increased iodine level 5 times to 3 mg/L according to Lean et al. (2021).

For livestock producers, it is important to evaluate the economic benefits of any future anti-methanogenic feed supplement. Even if regulations mandate the use of products to reduce methane emissions, farmers' financial burden could increase if animal performance is not improved simultaneously (e.g., improved productivity, efficiency, health, or product quality). The value of the improvement must therefore be enough to cover the cost of the product or additional incentive programs must be established to achieve widespread adoption.

Cost effective and readily implemented strategies are needed to help all farmers adopt clean farming practices and to provide meaningful enteric methane reduction technologies with the potential to be profitable or at a minimum a highly cost-effective forms of methane mitigation.

This present technology overcomes at least some of these challenges observed with the drawbacks observed in the field and provides such new and useful compositions and methods.

### 4. SUMMARY OF THE INVENTION

In one aspect, the present disclosure provides a composition comprising: at least one exogenous organohalide and a macroalgae substrate, wherein the at least one organohalide compound is not derived from macroalgae. In certain embodiments, the provided compositions are useful as anti-methanogenic ruminant feed supplements.

In certain embodiments, the composition comprises a viscous edible coating. In some embodiments, the viscous edible coating in present in an amount from about 15-55% by weight of the composition. In some embodiments, the viscous edible coating in an amount from about 25-50% by weight of the composition. In some embodiments, the viscous edible coating in an amount from about 40-45% by weight of the composition.

In certain embodiments of any of the provided compositions, the composition comprises at least one exogenous organohalide is selected from a compound of Formula I, Formula II and Formula III or a salt thereof: wherein X is a halogen selected from Br, I, and Cl, or H; wherein the compound of Formula I, Formula II and Formula III comprises at least one halogen. In certain embodiments, the at least one exogenous organohalide is bromoform. In certain of these embodiments, the organohalide is present in an amount of at least 0.5% by wt, at least 0.6% by wt, at least 0.7% by wt, at least 0.8% by wt, at least 0.9% by wt, at least 1.0% by wt, at least 1.2% by wt, at least 1.3% by wt, at least 1.4% by wt, at least 1.5% by wt, or at least 1.6% by wt. In particular embodiments, the at least one exogenous organohalide is present in an amount of at least about 0.8% by dry weight of the composition. In particular embodiments, the organohalide is bromoform.

In certain embodiments of the provided compositions, the macroalgae substrate is characterized as having bromoform in an amount of 0.5%, 0.4%, 0.3%, 0.2%, 0.1%, 0.09%, 0.08%, or 0.07% by dry weight or less.

In certain embodiments the provided composition is prepared by a method that comprises a lyophilization step. In certain of these embodiments, the amount of organohalide present in the composition after lyophilization (under vacuum at −50 C for 2 hours) is at least 0.5% by wt, at least 0.6% by wt, at least 0.7% by wt, at least 0.8% by wt, at least 0.9% by wt, at least 1.0% by wt, at least 1.2% by wt, at least 1.3% by wt, at least 1.4% by wt, at least 1.5% by wt, or at least 1.6% by wt. In certain of these embodiments, the organohalide is bromoform.

In certain embodiments of any of the provided compositions, the amount of organohalide present after storage under vacuum for 65 weeks at 25° C. is at least 80% of the starting concentration.

The composition of any proceeding claim, comprising 0.5 to 1.5% bromoform by dry weight and wherein administration in a range from 0.4 to 0.6 wt/wt of feed supplement to total dry matter intake results in 60%-100% methane reduction compared to an unsupplemented animal. In certain of these embodiments, the feed supplement is lyophilized and stored in a vacuum sealed container.

Another aspect of the present disclosure provides a method for reducing enteric methane production, said method comprising administering to a ruminant animal a composition according to any one of the preceding embodiments or embodiments disclosed herein. In certain of these embodiments, the composition is administered at a rate of 0.3 to 1.0% total dry matter intake.

Another aspect of the present disclosure provides a non-therapeutic method for reducing total gas production and / or methane production in ruminants said method comprising the step of administering to said animal an effective amount of a feed supplement according to any preceding embodiment or any embodiment disclosed herein. In certain embodiments, the composition is administered at a rate of 0.3 to 1.0% total dry matter intake.

Another aspect of the present disclosure provides a method of supplementing the diet of a ruminant with bromoform, the method comprising: said method comprising the step of administering to said animal an effective amount of a feed supplement according to any preceding embodiment.

Another aspect of the present disclosure provides a method of making a ruminant feed supplement, the method comprising: obtaining a macroalgae substrate; contacting the substrate with a fluid comprising one or more organohalides; and a viscous substrate. In certain of these embodiments, the method further comprises a lyophilization step that is conducted until the product is dry.

### 5. BRIEF DESCRIPTION OF THE DRAWINGS

These and other features, aspects, and advantages of the present invention will become better understood with regard to the following description, and accompanying drawings, where:

FIG. 1 illustrates the change in bromoform concentration over 24 hours at room temperature in a container open to the atmosphere.

FIG. 2 illustrates the change in bromoform concentration over long term storage in a vacuum sealed bag and stored in a freezer at −20° C.

FIG. 3 illustrates the dose dependent decrease in methane produced in both the Diet A and Diet B supplemented cattle

FIG. 4 illustrates the rate of gas produced and propionate proportion of the gas produced.

FIG. 5 illustrates precipitous methane reduction in exhaust air overtime in Holstein steers supplemented with Formulation 1 at 0.5% of the total ration dry matter.

### 6. DESCRIPTION OF EXAMPLE EMBODIMENTS

### 6.1. Definitions

The present technology is explained in greater detail below. This description is not intended to be a detailed catalog of all the diverse ways in which the technology may be implemented, or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure which variations and additions do not depart from the present technology. Hence, the following description is intended to illustrate some particular embodiments of the technology, and not to exhaustively specify all permutations, combinations, and variations thereof.

As used herein, the singular form “a”, “an” and “the” include plural referents unless the context clearly dictates otherwise.

The recitation herein of numerical ranges by endpoints is intended to include all numbers subsumed within that range (e.g., a recitation of 1 to 5 includes 1, 1.5, 2, 2.75, 3, 3.80, 4, 4.32, and 5).

The term “about” is used herein explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. For example, the term “about” in the context of a given value or range refers to a value or range that is within 20%, preferably within 15%, more preferably within 10%, more preferably within 9%, more preferably within 8%, more preferably within 7%, more preferably within 6%, and more preferably within 5% of the given value or range.

The expression “and/or” where used herein is to be taken as specific disclosure of each of the two specified features or components with or without the other.

Use of the terms macroalga, macroalgae, algae, alga, seaweed, and kelp are used interchangeably herein to refer to one or more macroalgae. Macroalgae comprise a vast number of diverse live organisms, possibly surpassing 25,000 species (Santos et al., 2015 Food Chemistry, 183, 122-128), of macroscopic, multicellular, and marine algae (Hurd, Harrison, Bischof, & Lobban, 2014). They belong to three different and relatively unrelated eukaryotic lineages corresponding to taxonomically distant groups, usually termed brown (Phaeophyceae), red (Rhodophyceae) and green (Chlorophyceae) macroalgae. Brown algae contain a distinct chlorophyll composition (types a and c) and carotenoids (mainly fucoxanthin, which renders these macroalgae brown). Red algae, besides chlorophylls and carotenoids, are rich in phycobilin. Green algae have chlorophylls a and b, as well as carotenoids, in the chloroplasts (Pereira, et al. 2016 Edible seaweeds of the world. CRC Press (Taylor and Francis Group). There is a great biological diversity among seaweeds, concerning life cycle and fertilization or morphogenetic strategies. Size also varies, being several meters long for some macroalgae and displaying a high level of complexity (Pereira, 2016).

Use of the term “animals” herein is intended to refer to ruminant animals. Ruminants are hoofed herbivorous grazing or browsing mammals that are able to acquire nutrients from plant-based food by fermenting it in a specialized stomach prior to digestion, principally through microbial actions.

### 6.2. Compositions—Ruminant Feed Supplement

In an aspect of the provided technology, the present investigators discovered that feed supplements comprising an alga substrate enhanced with exogenous bromoform achieved surprising levels of methane inhibition not previously reported, promoted growth of ruminant animals as well as increased the quality of products derived therefrom.

According to the present disclosure, there is provided a composition for reducing methane emission in ruminant animals, the composition comprising an alga substrate enhanced or supplemented by addition of an exogenous organohalide. Any such “composition” as referred to herein may also be referred to as the “animal feed supplement.”

In certain embodiments, the composition of the present invention comprises an alga substrate and at least one of an exogenous organohalide, i.e., an organohalide that was not synthesized by the alga substrate itself. In certain embodiments, the at least one organohalide compound is not derived from macroalgae.

In an aspect of the present disclosure, the animal feed supplement is “agnostic” to the macroalgae substrate thus permitting use of any alga substrate having desirable properties according to its intended use or that is commercially available or has additional environmental benefits. The present technology resolves challenges related to limited supply of suitable A. taxiformis and improves farmers compliance with measures for mitigating production of greenhouse gases. In certain embodiments of the animal feed supplement, the alga substrate has one or more of: a preferred palatability profile (e.g., lower odor), preferred iodin content, preferred nutrition profile.

In some embodiments, the composition comprises more than one exogenous organohalide. In some embodiments, the exogenous organohalide composition profile includes two, three, four or more synthetic organohalide species that are found in naturally occurring Asparagopsis taxiformis. In some embodiments the composition the least one of the two, three, four or more organohalide species are present in the composition at a higher concentration (% DW) than that found in naturally occurring Asparagopsis taxiformis.

### 6.2.1. Exogenous Organohalides

Organohalides (also referred to as organohalogens) are organic compounds that contain at least one halogen.

In some embodiments, the at least one organohalide is selected from a compound of Formula I, Formula II and Formula III or a salt thereof:

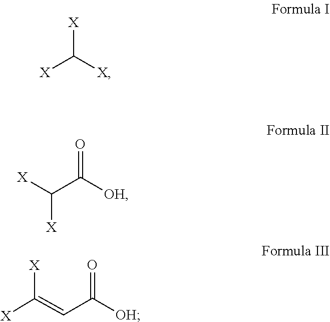

wherein X is selected from Br, I, Cl and H; and wherein the organohalide comprises at least one halogen.

In some embodiments, the organohalide is a C1-C6 alkyl halogen compound. In some embodiments, the organohalide comprises chlorine, bromine, iodine, or a combination thereof. In some embodiments, the organohalide is selected from CH3Cl; CH3Br; CH3I; CH2Cl2; CH2Br2; CH2I2; CHCl3; CHBr3; CHI3; CCl4; CBr4; CH2CIBr; CH2ClI; CH2BrI; CHBr2Cl; CHBrI2; CHBrClI; CHBr2I; CHBrCl2; CH3CH2Br; CH3CH2I; CH3CH2CH2I; CH3(CH2)3I; CH3(CH2)4Br; CH3(CH2)4I; (CH3)2CHI; CH3CH2CH(CH3)I; (CH3)2CHCH2I; BrCH2CH2Br; ClCH═CCl2; and CH3CH2CH2CH2I. In some embodiments, the organohalide is a trihalomethane. In some embodiments, the organohalide is an organobromine compound, more preferably wherein the organohalide is bromoform (CHBr3).

In some embodiments, one or more organohalide is selected from one or more of bromoform, iodoform, chloroform, dibromoacetic acid, bromochloroacetic acid, bromoiodoacetic acid), dibromochloromethane, dibromoiodomethane (the other variations between Cl, I, Br), and 3,3′dibromoacrylic acid.

Biological sources of organohalides are organohalide-rich marine macroalgae. For example, organohalide-rich marine macroalgae includes at least one species of marine macroalgae selected from the group consisting of: Asparagopsis armata; Asparagopsis taxiformis; Dictyota species; Oedogonium species; Ulva species; and Cladophora patentiramea. Thus, in some embodiments, the organohalide derives from an organohalide-rich marine macroalgae, for example, selected from the group consisting of: Asparagopsis armata; Asparagopsis taxiformis; Dictyota species; Oedogonium species; Ulva species; and Cladophora patentiramea. In alternative embodiments, the at least one organohalide is not derived from macroalgae. In some embodiments, the organohalide is an organobromine compound, preferably bromoform.

In other embodiments, the organohalides are produced by bacteria, fungi, and cyanobacteria. For example, the bacteria includes one species of bacteria selected from the group consisting of: Streptomyces sp. and Zobellia galactanivorans. For example, the fungi includes one species of fungi selected from the group consisting of: Pyricularia oryzae, Curvularia inaequalis, Pyrenophora tritici-repentis and Embellisia didymospora. For example, the cyanobacteria includes one species of cyanobacteria selected from the group consisting of: Trichodesmium erythraeum, Synechococcus sp. and Acaryochloris marina. Thus, in some embodiments, the organohalide derives from an bacteria, fungi, and cyanobacteria. In alternative embodiments, the at least one organohalide is not derived from a bacteria, fungi, and cyanobacteria.

In other embodiments, the organohalide is synthetic, i.e., the organohalide is chemically synthesized. In other embodiments, the organohalide is produced by a recombinant yeast. In some examples, the organohalide is an organobromine compound, preferably bromoform.

In some embodiments, the compositions of the current technology comprise the one or more organohalide in a total amount of more than 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, or 0.1 w/w % dry weight. In some examples, the one or more organohalide is an organobromine compound, preferably bromoform.

In certain embodiments, the compositions of the current technology comprise a bromoform amount of more than 0.3 w/w % dry weight. In certain embodiments, the compositions of the current technology comprise a bromoform amount of more than 0.5 w/w % dry weight. In certain embodiments, the compositions of the current technology comprise a bromoform amount of more than 0.6 w/w % dry weight. In certain embodiments, the compositions of the current technology comprise a bromoform amount of more than 0.7 w/w % dry weight. In certain embodiments, the compositions of the current technology comprise a bromoform amount of more than 0.8 w/w % dry weight. In certain embodiments, the compositions of the current technology comprise a bromoform amount of more than 0.9 w/w % dry weight. In certain embodiments, the compositions of the current technology comprise a bromoform amount of more than 1.0 w/w % dry weight. In certain embodiments, the compositions of the current technology comprise a bromoform amount of more than 1.1 w/w % dry weight. In certain embodiments, the compositions of the current technology comprise a bromoform amount of more than 1.2 w/w % dry weight. In certain embodiments, the compositions of the current technology comprise a bromoform amount of more than 1.3 w/w % dry weight. In certain embodiments, the compositions of the current technology comprise a bromoform amount of more than 1.4 w/w % dry weight. In certain embodiments, the compositions of the current technology comprise a bromoform amount of more than 1.5 w/w % dry weight. In certain embodiments, the compositions of the current technology comprise a bromoform amount of more than 1.6 w/w % dry weight. In certain embodiments, the compositions of the current technology comprise a bromoform amount of more than 1.7 w/w % dry weight.

In some embodiments, the concentration of organohalide in the composition is greater than 100 nM, or greater than 110 nM, or greater than 120 nM, or greater than 130 nM, or greater than 140 nM, or greater than 150 nM. In some examples, the organohalide comprises an organobromine compound, preferably bromoform.

In another preferred embodiment, the present technology provides for a feed supplement for beef cattle, dairy cattle and other ruminants comprising a minimum of 1.5% of bromoform by dry weight.

In another preferred embodiment, the present technology provides for a feed supplement for beef cattle, dairy cattle and other ruminants comprising a minimum of 1.0% of bromoform by dry weight.

In another preferred embodiment, the present technology provides for a feed supplement for beef cattle, dairy cattle and other ruminants comprising a minimum of 0.9% of bromoform by dry weight.

In another preferred embodiment, the present technology provides for a feed supplement for beef cattle, dairy cattle and other ruminants comprising a minimum of 0.8% of bromoform by dry weight.

In another preferred embodiment, the present technology provides for a feed supplement for beef cattle, dairy cattle and other ruminants comprising a minimum of 0.7% of bromoform by dry weight.

In another preferred embodiment, the present technology provides for a feed supplement for beef cattle, dairy cattle and other ruminants comprising a minimum of 0.6% of bromoform by dry weight.

### 6.2.2. Substrate

The substrate of the present disclosure is not particularly limited and can be any substrate without limitation

In certain embodiments, the substrate is a macroalga substrate and includes all alga and alga derived products suitable for animal consumption and any combinations thereof.

In certain embodiments, the bromoform content of the alga substrate is less than 0.5%, 04%, 0.3%, 0.2%, 0.1%, 0.09%, 0.08%, 0.07%, or 0.06% bromoform wt/wt of dry weight. In certain embodiments, the bromoform content of the alga substrate is less than 0.5% bromoform wt/wt of dry weight. In certain embodiments, the bromoform content of the alga substrate is less than 0.4% bromoform wt/wt of dry weight. In certain embodiments, the bromoform content of the alga substrate is less than 0.3% bromoform wt/wt of dry weight. In certain embodiments, the bromoform content of the alga substrate is less than 0.2% bromoform wt/wt of dry weight.

In certain embodiments, the alga substrate comprises an alga selected from an alga described in Pereira, et al. 2016 Edible seaweeds of the world. CRC Press (Taylor and Francis Group).

In certain embodiments, the alga substrate comprises an alga selected from one of the following categories and algal lineages: Euglenophyte, Chrysophyta, Pyrrophyta, Chlorophyta, Rhodophyta, Paeophyta, and anthophyta.

In certain embodiments, the alga substrate comprises an alga selected from one or more of Ascophyllum nodosum, Asparagopsis taxiformis, Alaria esculenta, Fucus vesiculosus, Palmaria palmata, Chondrus crispus, Laminaria hyperborea, Laminaria digitata, Saccharina latissima, Porphyra umbilicalis, Pyropia yezoensis, Ulva fenestrata, Ulva lactuca, Ulva fasciata, and Macrocystis pyrifera and mixtures thereof.

In certain embodiments, the alga substrate comprises a brown algae of family Laminariaceae.

In certain embodiments, the alga substrate comprises an alga selected from: Arthrothamnus, Cymathere, Laminaria, Macrocystis, Nereocystis, Pelagophycus, Postelsia, Pseudolessonia, Saccharina, and Streptophyllopsi and mixtures thereof.

In certain embodiments, the alga substrate comprises an alga selected from Laminaria hyperborea, Ascophyllum nodosum, Laminaria digitata and mixtures thereof.

In certain embodiments, the alga substrate comprises an alga selected from a red algae in the family Gracilaria. In certain embodiments, the alga substrate is selected from Asparagopsis armata, Asparagopsis taxiformis, Dictyota spp (e.g. Dictyota bartayresii), Oedogonium spp, Ulva spp, C. patentiramea and mixtures thereof. In certain of these embodiments, the bromoform content of the red alga is less than 0.5% bromoform wt/wt of dry weight.

In certain embodiments, the alga substrate comprises an alga selected from Laminaria sp., Fucus sp., Ascophyllum nodosum, Chondrus crispus, Porphyra sp., Ulva sp., Sargassum sp., Gracilaria sp. and Palmaria palmata, Undaria pinnatifida and mixtures thereof.

In certain embodiments, the alga substrate comprises an alga selected from genus Acrosiphonia, Alaria, Laminaria, Mastocarpus, Palmaria, Porphyra, Ulva and mixtures thereof.

In certain embodiments, the alga substrate comprises an alga selected from Ascophyllum nodosum, Laminaria sp., e.g., Laminaria digitata, Ulva sp., Codium sp., and mixtures thereof.

In certain embodiments, the alga substrate comprises a derivative (i.e., product derived from) of alga. In particular embodiments, the alga substrate is an alginate product.

In certain embodiments, the alga substrate comprises commercial alginates produced from Laminaria hyperborea, Macrocystis pyrifera, Laminaria digitata, Ascophyllum nodosum, Laminaria japónica, Eclonia maxima, Lessonia nigrescens, Durvillea antarctica and Sargassum spp.

### 6.2.3. Coating

In an aspect of the present technology, it was discovered that viscous edible coatings enhance bromine retention in the final dry product. Such edible coatings include sweet syrups known in the art such as molasses, cane syrup, high fructose corn syrup and edible fats and waxes such as shortening, bees wax, and edible oils.

In certain embodiments the composition comprises a viscous edible coating in a minimal amount sufficient to coat the substrate.

In certain embodiments the composition comprises a viscous edible coating in an amount sufficient to reduce bromoform loss under freeze drying conditions for 2 hours wherein the bromoform loss is less than 50%, 40%, 30%, 20%, 10% or 5% of the original bromoform concentration (wt/wt). In certain embodiments, the bromoform loss is less than 30% of the original bromoform concentration (wt/wt). In certain embodiments, the bromoform loss is less than 20% of the original bromoform concentration (wt/wt). In certain embodiments, the bromoform loss is less than 10% of the original bromoform concentration (wt/wt).

In certain embodiments the composition comprises a viscous edible coating in an amount of at least 5%, 10%, 15%, 20%, 25%, 30%, 35%, 40%, 45%, 50% or 55% by weight of total composition or within a range defined by any two of the preceding percentages. For example, in certain embodiments the composition comprises a viscous edible coating in an amount from 20-50% by weight of total composition. In certain embodiments the composition comprises a viscous edible coating in an amount from 25-50% by weight of total composition. In certain embodiments the composition comprises a viscous edible coating in an amount from 30-50% by weight of total composition. In certain embodiments the composition comprises a viscous edible coating in an amount from 35-50% by weight of total composition. In certain embodiments the composition comprises a viscous edible coating in an amount from 40-50% by weight of total composition. In certain embodiments the composition comprises a viscous edible coating in an amount from 20-40% by weight of total composition. In certain embodiments the composition comprises a viscous edible coating in an amount from 25-40% by weight of total composition. In certain embodiments the composition comprises a viscous edible coating in an amount from 30-40% by weight of total composition. In certain embodiments the composition comprises a viscous edible coating in an amount from 15-30% by weight of total composition. In certain embodiments the composition comprises a viscous edible coating in an amount from 20-30% by weight of total composition.

In certain embodiments, the ruminant feed supplement comprises an alga substrate, one or more of an exogenous organohalide and a coating. In certain of these embodiments, the ruminant feed supplement comprises an alga substrate, bromoform and molasses.

In certain embodiments, the ruminant feed supplement comprises an alga substrate, at least 0.8% bromoform by weight and between 45-55% by weight molasses.

### 6.2.4. Improved Organohalide Stability

In another aspect, the animal supplements provided herein have improved organohalide stability profile. In certain embodiments, the supplement has a slower loss of bromoform compared to A. taxiformis under the same conditions.

### 6.2.4.1 Change in Organohalide Concentration Over Time

In some embodiments, the animal supplement of the present disclosure is characterized wherein the amount of organohalide concentration (wt/wt) present after 5 hours when left open to the atmosphere and maintained within room temperature is at least 60%, 62%, 64%, 66%, 68%, 70%, 72%, 74%, 76%, 78%, 80%, 82%, 84%, 86%, 88%, 90%, 92%, 94%, 96%, 98%, 99% or 100% of the original organohalide concentration. In certain embodiments, the amount of organohalide concentration (wt/wt) present after 5 hours when left open to the atmosphere and maintained within room temperature is at least 80%.

In some embodiments, the ruminant supplement of the present disclosure is characterized wherein the amount of organohalide concentration (wt/wt) present after being stored below 32 F in a vacuum sealed bag after up to 180 days is reduced by 5%, 10%, 12%, 14%, 16%, 18%, 20%, 22%, 24%, 26% or less. In certain embodiments, the ruminant supplement of the present disclosure is characterized wherein the amount of organohalide concentration (wt/wt) present after being stored below 32 F in a vacuum sealed bag after up to 180 days is reduced by less than 20%.

In some embodiments, the ruminant supplement of the present disclosure is characterized wherein the rate of change of the organohalide concentration (wt/wt) while being maintained in open atmosphere and at room temperature is 0.1 or less. In certain of these embodiments, the rate of change of the organohalide is 0.09 or less. In certain of these embodiments, the rate of change of the organohalide is 0.08 or less. In certain of these embodiments, the rate of change of the organohalide is 0.07 or less. In certain of these embodiments, the rate of change of the organohalide is 0.06 or less. In certain of these embodiments, the rate of change of the organohalide is 0.05 or less. In certain of these embodiments, the rate of change of the organohalide is 0.05 or less. In certain of these embodiments, the rate of change of the organohalide is 0.03 or less. In certain of these embodiments, the rate of change of the organohalide is 0.02 or less. In certain of these embodiments, the rate of change of the organohalide is 0.01 or less.

### 6.2.4.2 Control of Iodine Levels

Milk iodine levels are directly correlated to iodine intake levels of the cow, with about 2% of consumed iodine being directly passed into the milk. If cows exceed their daily iodine intake levels significantly, their milk can exceed the recommended iodine intake levels for humans. Meat iodine levels from cattle fed a diet including red marine algae at 0.5% of organic matter daily are elevated relative to cattle not fed red marine algae.

An aspect of the present technology is the provision of a feed supplement comprising a therapeutically effective amount bromoform sufficient to reduce methanogenesis as described in section 5.4.2.1 and an amount of iodine such that ruminants fed according to the methods described herein, e.g., the level of iodine in the ruminants blood, meat or milk are below industry standards.

In certain embodiments, the alga substrate has an iodine level sufficient to produce a ruminant feed supplement according to the present technology characterized by a ratio of organohalide mg/g to iodine ppm of greater than about 150, thus minimizing odor, reducing risk of iodine contamination of ruminant products and optimizing palatability.

In certain embodiments, the compositions of the current technology comprise an alga substrate exhibiting an iodine content of less than 0.1, 0.09, 0.08, 0.07, 0.06, 0.05, 0.04, 0.03, 0.02 or 0.01 w/w % dry weight.

In certain embodiments, the compositions of the current technology comprise an alga substrate exhibiting an iodine content of less than 0.145 w/w % dry weight.

In certain embodiments, the compositions of the current technology are characterized by an iodine to bromoform ratio by wt. of less than 0.1, 0.09, 0.08, 0.07, 0.06, 0.05, 0.04, 0.03,0.02, 0.012 or 0.01. In certain embodiments, the compositions of the current technology are characterized by an iodine to bromoform ratio by wt. of less than 0.04, 0.03, 0.02. 0.012 or 0.01. In certain embodiments, the compositions of the current technology are characterized by an iodine to bromoform ratio by wt. of less than 0.012.

### 6.3. Formulations

In accordance with the present disclosure, the ruminant feed supplement is a solid (e.g. powder, granules, pellets) composition. The ruminant feed supplement may be formulated to include any animal feed additive known in the art provided the anti-methanogenic effect is not negatively affected. In certain embodiments, as long as the final organohalide concentration is 0.5% (wt/wt) or more, additional additives are not particularly restricted.

### 6.3.1. Other Additives

In some embodiments, the compositions and methods of the present technology provide for ruminant supplements and ruminant supplementation methods that inhibit methane production in ruminants that further comprise appropriate mineral supplements as part of the feed supplement formulation.

In certain embodiments, the additive includes vitamins, minerals, antibiotics, growth stimulants and combinations thereof. For example, the composition may comprise other biologically active ruminant feed supplements, for example suitable for reducing methane production/emissions and/or increasing availability of nutrients to the ruminant. The vitamin may be any one or a combination of vitamin A, vitamin D, vitamin E, vitamin K, thiamine, riboflavin, pyridoxine, cyanocobalamin, carotenoids (including betacarotene, zeaxanthin, lutein and lycopene), niacin, folic acid, pantothenic acid, biotin, vitamin C, choline, inositol, and salts and derivatives thereof. The mineral may be any one or more of calcium, phosphorous, magnesium, iron, zinc, manganese, copper, cobalt, boron, iodine, sodium, potassium, molybdenum, selenium, chromium, fluorine, and chloride. In certain embodiments, the ruminant feed supplement comprises from about 0.001 wt % to about 25 wt % of any of the above additives or from about 0.01 wt % to about 15 wt % or from about 0.1 wt % to about 5 wt % of any of the above additives. In certain of these embodiments, the additives included calcium, trace mineral premix and vitamin ADE premix.

In certain embodiments, the feed supplement according to the present disclosure comprises one or more of the following additional components (percent are percent by dry weight of the feed supplement): 1-50% molasses, 1-50% starch, e.g., potato starch, pea starch, corn starch, Ameri-Bond™ (2×), wheatmitts, Nutraflex® Plus, Probond, 1-10% oral parasite control, 1-50% edible oil, e.g., olive oil, corn oil, avocado oil, 1-5% mineral, e.g., NaCl, KCl, 1-5% Calcium, Magnesium, Phosphorous, Potassium, Sodium, Sulfur, Vitamin A (stabilized form), vitamin D, vitamin E, Aluminum, 1-100 ppm Chromium, cobalt, Copper, iodine, Iron, Manganese, Molybdenum, Nickel, Selenium, Zinc; 1-50% feed substrate, e.g., Bahiagrass Pasture, Bermudagrass Pasture, Bermudagrass Hay, Fescue Pasture, Fescue Hay, Corn, Corn Silage, Corn Gluten Feed, Cottonseed Meal, Whole Cottonseed, Soyhulls, Soybean Meal, Citrus Pulp, and 1-15% probiotics, antibiotics or a mixture of both.

### 6.4. Ruminant Feed

The three main types of ruminant feed include roughages, concentrates and mixed feeds. In general, roughages contain a higher percentage of crude fiber and a lower percentage of digestible nutrients than concentrates. For example, roughages may be defined as containing equal to or greater than 20 wt % crude fiber and equal to or less than 60 wt % total digestible nutrients. Roughages may include, for example, dry roughages (e.g. hay, straw, artificially dehydrated forages containing at least 90 wt % dry matter), silages (formed from green forages such as grass, alfalfa, sorghum and corn and preserved in a silo at dry matter contents of 20 to 50%), and pastures (e.g. green growing pastures providing forage that has a high water content and generally less than 30% dry matter). The two basic types of roughages include grasses and legumes. Grasses are higher in fiber and dry matter than legumes. Legumes are higher in proteins, metabolizable energy, vitamins, and minerals. Concentrates contain a relatively lower percentage of crude fiber and a higher percentage of digestible nutrients than roughages. For example, concentrates may be defined as containing less than 20 wt % crude fiber and greater than 60 wt % total digestible nutrients. Concentrates may include, for example, energy-rich grains and molasses. Corn, wheat, oats, barley, and milo (sorghum grain) are energy-rich grains, containing about 70 to 80 wt % total digestible nutrients.

The ruminant feed may, for example, comprise from about 0.0001 wt % to about 10 wt % of the ruminant feed supplement, based on the total dry weight of the ruminant feed. The ruminant feed may, for example, comprise from about 0.3 wt % to about 10 wt % of ruminant feed supplement, based on the total dry weight of the ruminant feed.

In certain embodiments, the ruminant feed is supplemented with 0.5 wt % of the ruminant feed supplement composition provided by the present disclosure.

### 6.4.1. Dosing Schedules

In certain embodiments of the present disclosure, ruminant animal feed is supplemented at a rate of at least about 0.2%, 0.25%, 0.3%, 0.35%, 0.40%, 0.45%, 0.50%, or 0.55% percent of total dry weight. In certain embodiments of the present disclosure, ruminant animal feed is supplemented at a rate of about 0.2%, 0.25%, 0.3%, 0.35%, 0.40%, 0.45%, 0.50%, or 0.55% percent of total dry weight. In certain embodiments, of the present disclosure, ruminant animal feed is supplemented at a rate of 0.40%, 0.45%, 0.50%, or 0.55% percent of total dry weight.

In general, ruminants have different supplementation rates depending on whether they are being raised for dairy or meat, are grazed solely on pasture, solely on grain, or on transition diets. Particularly, the methods and supplementation rates and methods described herein consider the amount of neutral dietary fiber.

### 6.4.2. Results Observed for Ruminants Supplemented With the Compositions According to the Present Disclosure

In embodiments of the present disclosure, the ruminant animals to be supplemented with the compositions provided herein include cattle, sheep, goat, buffalo. In certain embodiments, the ruminant is cattle. In certain of these embodiments, the cattle is selected from Holstein, Holstein Friesier, Jersey, Brangus, Angus, Brahman, Red Angus, Aberdeen, Hereford, Japanese Black, Limousin, Piedmontese, Beef Master, Gelbvieh, Simmental, Brown Swiss, Guernsey, Ayrshire, French Brown, Burlina, Red & White, and Milking Shorthorn.

### 6.4.2.1 Methane Reductions

In one embodiment, ruminants fed the supplemented diet exhale less methane than ruminants fed the unsupplemented diet. In one embodiment, the ruminants supplemented with the compositions of the present technology exhale about 10%, 20%, 30%, 40%, 50%, 60%, 70%, 80%, 90%, 100% or less methane than ruminants fed the same unsupplemented diet, or within a range defined by any two of the preceding values e.g., about 10% to 20%, 20% to 30%, 30% to 40%, 40% to 50%, 50% to 60%, 60% to 70%, 70% to 80%, 80% to 90%, 90% to 99% or 100% less methane than ruminants fed the same unsupplemented diet. In one embodiment, the ruminants supplemented with the compositions of the present technology exhale at least about 75%, 80%, 85%, 90%, 91%, 92%, 93%, 94%, 95%, 96%, 97%, 98%, 99% of carbon dioxide than ruminants fed the same unsupplemented diet.

### 6.4.2.2 Propionate Ratios

In one embodiment, the ruminants supplemented with the compositions of the present technology have a propionate to acetate ratio in their rumen about 1%, 2%, 3%, 4%, 5%, 6%, 7%, 8%, 9%, 10% or 11% greater than ruminants fed the same unsupplemented diet. In one embodiment, the ruminants supplemented with the compositions of the present technology have a propionate to acetate ratio in their rumen about 12%, 13%, 14%, 15%, 16%, 17%, 18%, 19%, 20% or 21% greater than ruminants fed the same unsupplemented diet. In one embodiment, the ruminants supplemented with the compositions of the present technology have a propionate to acetate ratio in their rumen about 10% to 20%, 21% to 30%, 31% 40%, 41% to 50%, 51% to 60%, 61% to70%, 71% to 80%, 81% to 90%, 91% to 99% or 100% greater than ruminants fed the same unsupplemented diet.

### 6.4.2.3 Increased Milk Production

In one embodiment, the ruminants supplemented with the compositions of the present technology provide about 1%, 2%, 3%, 4%, 5%, 6%, 7%, 8%, 9%, 10%, 11%, 12%, 13%, 14%, 15%, 16%, 17%, 18%, 19%, 20% or 21% more milk than ruminants fed the same unsupplemented diet. In one embodiment, the ruminants supplemented with the compositions of the present technology provide an amount of milk within a range of any two of the preceding percentages compared to ruminants fed the same unsupplemented diet.

### 6.4.2.4 Feed Efficiency

In one embodiment, the ruminants supplemented with the compositions according to the present disclosure gain about 1%, 2%, 3%, 4%, 5%, 6%, 7%, 8%, 9%, 10% or 11% more weight than ruminants fed the same unsupplemented diet. This weight gain difference may be average weight at slaughter or other time in the growth cycle. In one embodiment, the ruminants supplemented with the compositions of the present technology gain about 12%, 13%, 14%, 15%, 16%, 17%, 18%, 19%, 20% or 21% more weight than ruminants fed the same unsupplemented diet. This weight gain difference may be average weight at slaughter or other time in the growth cycle.

In one embodiment, the ruminants supplemented with the compositions of the present technology grow about 1%, 2%, 3%, 4%, 5%, 6%, 7%, 8%, 9%, 10% or 11% faster than ruminants fed the same unsupplemented diet. This weight gain difference between supplemented and supplemented ruminants may defined as average daily weight gain. In one embodiment, the ruminants supplemented with the compositions of the present technology grow about 12%, 13%, 14%, 15%, 16%, 17%, 18%, 19%, 20% or 21% faster than ruminants fed the same unsupplemented diet. This weight gain difference between supplemented and supplemented ruminants may defined as average daily weight gain.

In one embodiment, the ruminants supplemented with the compositions of the present technology provide about 22%, 23%, 24%, 25%, 26%, 27%, 28%, 29%, 30% or 31% more milk than ruminants fed the same unsupplemented diet.

In one embodiment, ruminants fed the supplemented diet exhale more hydrogen than ruminants fed the unsupplemented diet. In one embodiment, the ruminants supplemented with the compositions of the present technology exhale about 10% to 20%, 21% to 30%, 31% to 40%, 41% to 50%, 51% to 60%, 61% to 70%, 71% to 80%, 81% to 90%, 91% to 99% or 100% more hydrogen than ruminants fed the same unsupplemented diet. In one embodiment, the ruminants supplemented with the compositions of the present technology exhale about 1%, 2%, 3%, 4%, 5%, 6%, 7%, 8%, 9%, 10% or 11% more hydrogen than ruminants fed the same unsupplemented diet. In one embodiment, the ruminants supplemented with the compositions of the present technology exhale no less than about 1%, 2%, 3%, 4%, 5%, 6%, 7%, 8%, 9%, 10% or 11% of hydrogen than ruminants fed the same unsupplemented diet. In one embodiment, the ruminants supplemented with the compositions of the present technology exhale no less than about 10% to 20%, 21% to 30%, 31% to 40%, 41% to 50%, 51% to 60%, 61% to 70%, 71% to 80%, 81% to 90%, 91% to 99% or 100% of hydrogen than ruminants fed the same unsupplemented diet.

In one embodiment, the present technology provides for selection of alga substrate and addition of exogenous organohalides for achieving ruminant feed supplements with a ratio of the concentration of organohalides (mg/g) to iodine (ppm) of greater than 150:1, thus allowing the inclusion the feed supplement to the feed at lower levels, e.g., between about 10 g/day and about 60 g/day, therefore minimizing odor and the over-supplementation of iodine while maintaining the beneficial effects of reduced methane generation, faster growth, higher final body mass, fatty acid content quality, manure quality, leather quality, meat quality, and milk quality.

In some embodiments, the inclusion rate is 10, 15, 20, 25, 30, 35, 40, 45, 50, 55, or 60 g/day on a particular day. In other embodiments, the inclusion rate is 10, 15, 20, 25, 30, 35, 40, 45, 50, 55, or 60 g/day averaged over 2, 3, 4, 5, 6, or 7-day period. In one embodiment the inclusion rate is about 40 g/day about every 48 h.

When a ratio of organohalide compounds to iodine is referred to, the organohalide compounds include iodine containing compounds, but not elemental iodine.

In one embodiment, the expression “inorganic iodine” means iodide anions, salts, hypoiodites and the like. In one embodiment, the expression “organic iodine” refers to any compound comprising at least one iodine atom bound to at least one carbon atom.

In some embodiments, the compositions of the present technology is used in combination with other methane-reducing, quality and quantity enhancing components as disclosed in A. Cieslak, M. Szumacher-Strabel, A. Stochmal and W. Oleszek, Ruminant (2013), 7:s2, pp 253-265 & The Animal Consortium 2013.

### 6.5. Methods

### 6.5.1. Reducing Methane Production

Disclosed herein is a method of reducing methane, for example, reducing methane production by a ruminant, the method comprising administering the feed supplement or ruminant feed as described herein to a ruminant. Embodiments of the present disclosure pertain to ruminant livestock animals and include without limitation dairy cows, beef cattle, goats, sheep, and buffalos. In certain embodiments, the ruminant animal is selected from a Holstein, Holstein Friesier, Jersey, Brangus, Angus, Brahman, Red Angus, Aberdeen, Hereford, Japanese Black, Limousin, Piedmontese, Beef Master, Gelbvieh, Simmental, Brown Swiss, Guernsey, Ayrshire, French Brown, Burlina, Red & White, and Milking Shorthorn.

In certain embodiment, the compositions and methods of the present technology provide for ruminant supplements and ruminant supplementation methods that inhibit methane production in ruminants and do not require any changes in the typical supplementation regimes known in the art.

### 6.5.2. Improvement of Metabolic Efficiency

Herein is also disclosed are methods administration of the provided feed supplements, which are suitable for oral administration to ruminant to improve their metabolic efficiency, for the reduction of emitted methane for the increase of valuable ruminant products such as meat, fat, fibers, and milk.

### 6.5.2.1 Feeding Dosages and Schedules

In certain embodiments, the feed supplements provided herein when administered to said ruminants at certain effective doses of amount, typically administered daily, provides a surprising economic benefit through improved metabolic efficiency, and reduction of emitted methane for the increase of valuable ruminant products such as meat, fat, fibers, and milk.

The inhibition of methanogenesis occurs by different modes of action including for example: reducing methanogenic processes; by limiting or stopping enzymes involved in methanogenesis; or by reducing methanogenic organisms by limiting their growth or killing them.

The composition and method described herein may, for example, reduce methane production and/or emissions by at least about 10% (compared to methane production and/or emission if the ruminant feed supplement was not consumed). For example, the ruminant feed supplement may reduce methane production and/or emissions by at least about 10%, or at least about 15%, or at least about 25%, or at least about 30%, or at least about 35%, or at least about 40% or at least about 45%, or at least about 50%, or at least about 60%, or at least about 70%, or at least about 80%. The ruminant feed supplement described herein may, for example, reduce methane production and/or emissions by up to 100%. For example, the ruminant feed supplement may reduce methane production and/or emissions by up to about 99%, or up to about 98%, or up to about 97%, or up to about 96%, or up to about 95%, or up to about 90%, or up to about 85%, or up to about 80%, or up to about 75%, or up to about 70%. Methane emission may be measured according to any method known in the art such as those described in the examples section herein. This may, for example, be measured by the Hohenheim gas test or by using a manometer.

In certain embodiments, the current technology provides for a method of reducing methane production from ruminants by at least 70% by supplementing the food rations of such ruminants by at least 0.6% of their DMI with the feed supplements provided herein exhibiting a bromoform content of more than 2.5, 2.4, 2.3, 2.2, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, or 0.1 w/w % dry weight.

In certain embodiments, the current technology provides for a method of reducing methane production from ruminants by at least 70% by supplementing the food rations of such ruminants with the feed supplements provided herein exhibiting an iodine content of less than 0.1, 0.09, 0.08, 0.07, 0.06, 0.05, 0.04, 0.03, 0.02 or 0.01 w/w %

In certain embodiments, the current technology provides for a method of reducing methane production from ruminants by at least 70% by supplementing the food rations of such ruminants with the feed supplements provided herein exhibiting an iodine to bromoform ratio of less than 0.1, 0.09, 0.08, 0.07, 0.06, 0.05, 0.04, 0.03, 0.02, 0.012 or 0.01.

In certain embodiments, the current technology provides for a method of reducing methane reductions from ruminants by at least 80% by supplementing the food rations of such ruminants with the feed supplements provided herein exhibiting a bromoform content of more than 2.5, 2.4, 2.3, 2.2, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, or 0.1 w/w % dry weight.

In certain embodiments, the current technology provides for a method of reducing methane reductions from ruminants by at least 80% by supplementing the food rations of such ruminants with the feed supplements provided herein exhibiting an iodine content of less than 0.1, 0.09, 0.08, 0.07, 0.06, 0.05, 0.04, 0.03, 0.02 or 0.01 w/w %

In certain embodiments, the current technology provides for a method of reducing methane reductions from ruminants by at least 80% by supplementing the food rations of such ruminants with the feed supplements provided herein exhibiting an iodine to bromoform ratio of less than 0.1, 0.09, 0.08, 0.07, 0.06, 0.05, 0.04, 0.03, 0.02, 0.012 or 0.01. In certain embodiments, feed supplements provided herein exhibiting an iodine to bromoform ratio of less than 0.04, 0.03, 0.02, 0.012 or 0.01.

In certain embodiments, the current technology provides for a method of reducing methane production from ruminants by at least 80% by supplementing the food rations of such ruminants with the feed supplements provided herein such that the ruminant consumes less than 50 mg of iodine per 1 kg of dry matter intake.

In certain embodiments, the current technology provides for a method of reducing methane production from ruminants by at least 80% by supplementing the food rations of such ruminants with the feed supplements provided herein such that the ruminant consumes less than 40 mg of iodine per 1 kg of dry matter intake.

In certain embodiments, the current technology provides for a method of reducing methane production from ruminants by at least 80% by supplementing the food rations of such ruminants with the feed supplements provided herein such that the ruminant consumes less than 30 mg of iodine per 1 kg of dry matter intake.

In certain embodiments, the current technology provides for a method of reducing methane production from ruminants by at least 80% by supplementing the food rations of such ruminants with the feed supplements provided herein such that the ruminant consumes less than 20 mg of iodine per 1 kg of dry matter intake.

In certain embodiments, the current technology provides for a method of reducing methane production from ruminants by at least 80% by supplementing the food rations of such ruminants with the feed supplements provided herein such that the ruminant consumes less than 10 mg of iodine per 1 kg of dry matter intake.

In certain embodiments, the current technology provides for a method of reducing methane production from ruminants by at least 80% by supplementing the food rations of such ruminants with the feed supplements provided herein such that the ruminant consumes less than 5 mg of iodine per 1 kg of dry matter intake.

In certain embodiments, the current technology provides for a method of reducing methane production from ruminants by at least 80% by supplementing the food rations of such ruminants with the feed supplements provided herein such that the ruminant consumes less than 4 mg of iodine per 1 kg of dry matter intake.

In certain embodiments, the current technology provides for a method of reducing methane reductions from ruminants by at least 80% by supplementing the food rations of such ruminants with the feed supplements provided herein such that the ruminant consumes less than 3 mg of iodine per 1 kg of dry matter intake.

In one embodiment, intermittent feeding, is where the variation in feeding is done on a daily or weekly timescale. For example, one might imagine feeding with the feed supplements provided herein in the morning TMR but not the evening, or on weekdays but not weekends. This could yield a number of the benefits, for example reducing labor. Note that, though the actual feeding of the with the feed supplements provided herein is done on sub-week timescales as part of a feeding regimen lasting a couple weeks or more.

In another embodiment, intermittent feeding, is where the variation in feeding is done on a period of longer than a week. For example, one might imagine feeding with the feed supplements provided herein during lactation but not during pregnancy for dairy cows or removing beef steers from the feed supplement regimen two weeks before harvest.

In still another embodiment, feeding ruminants a higher dose of the feed supplements provided herein at the beginning of the dosing period, tapering to a lower dose towards the end of the dosing period. This could be useful, for example, to “kickstart” the benefits of the feed supplements provided herein.

In another embodiment, feeding ruminants a lower dose of the feed supplements provided herein at the beginning of the dosing period, increasing to a higher dose at the end of the dosing period. This could be useful, for example, to maintain or elongate the benefits of the feed supplements provided herein.

In still another embodiment, the current technology is used to alter the dose of the feed supplement based on the concentration of the active ingredient (e.g., bromoform) within the feed supplement.

In one embodiment, the increase of efficacy of the amount of methane emissions reduced per gram of provided feed supplement is at least about 5%, 10%, 20%, 30%, 40%, 50%, 75%, 100%, 150%, 200% or greater than 200%.

In one embodiment, a time varying dose of feed supplement is a supplementation schedule describing the regularly occurring intervals and amounts of feeding the AT composition. In another embodiment, the feed supplement is administered once every 48 h. In still another embodiment, feed supplement is administered every 72 h.

In another embodiment, a time varying dose of feed supplement is a supplementation schedule describing the supplementation time window and dose of the feed supplement based on discrete events such as reproductive status or time to market, or other such events that would limit the amount of iodine or halogenated organic materials allowable in the animal product or animal.

In another embodiment, the time varying dose supplementation schedule time window is adjusted to comport with ruminant feed regulations or consumer perception.

In one embodiment, the current technology provides for healthier ruminants and their offspring as compared to unsupplemented or continuously supplemented ruminants.

In still another embodiment, the current technology provides for higher quality ruminant products compared to unsupplemented or continuously supplemented ruminants.

In yet another aspect, the feed supplement compositions of the present technology is used to supplement feedlot ruminants on finishing diets at a daily supplementation rate of less than 200 g/day, less than about 150 g/day, less than about 100 g/day, or about or less than about 50 g/day of the algal biomass described here for ruminants on finishing diets.

Also disclosed herein is a method of inhibiting one or more methanogens comprising administering the composition or ruminant feed as described herein to an ruminant, in some embodiments, the compositions and combinations disclosed herein can be used to reduce one or more methanogens selected from Methanobacterium formicicum, Methanobacterium bryantii, Methanobrevibacter ruminantium, Methanobrevibacter millerae, Methanobrevibacter olleyae, Methanomicrobium mobile, Methanoculleus olentangyi, Methanosarcina barkeri, Methanobrevibacter boviskoreani, Methanobacterium beijingense, Methanoculleus marisnigri, Methanoculleus bourgensis, Methanosarcina mazei, Methanobrevibacter gottschalkii, Methanobrevibacter thaueri, Methanobrevibacter smithii, Methanosphaera stadtmanae, Methanobrevibacter woesei, Methanobrevibacter wolinii.

Also disclosed herein is a method of improving the metabolic efficiency of a ruminant, the method comprising administering the composition or the ruminant feed of the invention to a ruminant. The improvement in metabolic efficiency may result in an increased yield of ruminant products, for example, one or more of meat, fat, wool (i.e., fibers) and milk. Thus, the present composition or method can improve the meat and/or fat and/or wool and/or milk production of a ruminant.

The composition, ruminant feed and methods described herein may, for example, increase milk and/or meat and/or wool production by at least about 20% (compared to milk and/or meat and/or fat and/or wool production if the composition or ruminant feed was not consumed). For example, the composition or ruminant feed may increase milk and/or meat and/or fat and/or wool production by at least about 25%, or at least about 30%, or at least about 35%, or at least about 40%, or at least about 45%, or at least about 50%. The composition or ruminant feed described herein may, for example, increase milk and/or meat and/or fat and/or wool production by up to 100%. For example, the composition or ruminant feed may increase milk and/or meat and/or fat and/or wool production by up to about 95%, or up to about 90%, or up to about 85%, or up to about 80%, or up to about 75%, or up to about 70%. This is measured, for example, by volume of milk produced per day or by weight of ruminant or by weight of wool and/or fat and/or meat produced.

The composition and ruminant feed described herein may, for example, increase efficiency of milk and/or meat and/or wool production by at least about 20% (compared to the efficiency of milk and/or meat and/or fat and/or wool production if the composition or ruminant feed was not consumed). For example, the composition or ruminant feed described herein may increase efficiency of milk and/or meat and/or fat and/or wool production by at least about 25%, or at least about 30%, or at least about 35%, or at least about 40%, or at least about 45%, or at least about 50%. The composition or ruminant feed described herein may, for example, increase efficiency of milk and/or meat and/or fat and/or wool production by up to 100%. For example, the composition or ruminant feed described herein may increase efficiency of milk and/or meat and/or fat and/or wool production by up to about 95%, or up to about 90%, or up to about 85% or up to about 80%, or up to about 75%, or up to about 70%. Efficiency relates to the degree to which a particular biological process (e.g. milk, meat, fat, wool production) takes place per unit of nutrition consumed. This is measured, for example, by change in volume of milk produced per day or weight of ruminant or weight of wool or fat divided by the total nutrients consumed by the ruminant. The composition or ruminant feed described herein may, for example, increase nutrient availability by at least about 20% (compared to milk and/or meat and/or fat and/or wool production if the composition or ruminant feed was not consumed). For example, the composition or ruminant feed described herein may increase nutrient availability by at least about 25%, or at least about 30%, or at least about 35%, or at least about 40%, or at least about 45%, or at least about 50%. The composition or ruminant feed described herein may, for example, increase nutrient availability by up to 100%. For example, the composition or ruminant feed described herein may increase nutrient availability by up to about 95%, or up to about 90%, or up to about 85%, or up to about 80%, or up to about 75%, or up to about 70%. Nutrient availability refers to the amounts of nutrients that are available to the ruminant to be used for biological/metabolic functions.

In some embodiments, the ruminant is a cattle, goat, sheep, yak, deer, or antelope. In some embodiments, the ruminant is a cattle, goat, or sheep.

The composition or ruminant feed is administered orally to the ruminant. In some embodiments, the composition or ruminant feed is administered daily to the ruminant.

### 6.6. Methods of Manufacture

The compositions or ruminant feed supplements described herein is made by combining one or more organohalide(s) with an algal substrate.

According to the present disclosure, a person of skill in the art can select an alga substrate based on economic parameters or based on preferred ruminant feed properties such as nutrition content or iodine levels, and control of amount of bromine to apply to the substrate to produce a feed supplement providing significant methanogenesis as described in section ## while ensuring the fed ruminants maintain an iodine level, (e.g., blood, meat or milk) below government determined or informed threshold amounts.

In certain embodiments, The composition is prepared in the dry solid form, for example, powder form, and subject to further processing step depending on the types of the formulation for the intended finished products. The methods may further comprise a forming step, wherein the mixture is molded, pressed, spray dried or otherwise formed into a shape (e.g., bar, ball, pellet, clusters, tablet), preferably with dimensions and/or textures suitable for consumption by a ruminant of the types described herein. The methods may comprise housing the ruminant feed or ruminant feed supplement in a specific delivery device such as a syringe. The method may comprise forming ruminant feed supplement or ruminant feed into a bolus tablet that is intended to stay in the stomach of the ruminant.

The components are combined in suitable amounts to obtain a composition having the desired quantity of each component. For example, each component is combined by mixing or blending. For example, the one or more organohalide(s) and one or more organosulfur compound(s) and one or more polyphenol compound(s) is combined with a ruminant feed by placing the one or more organohalide(s) and one or more organosulfur compound(s) and one or more polyphenol compound(s) on top of the ruminant feed (top-dressing).

Potential methods for incorporation of organohalide into substrate:
Soaking substrate in a solution containing organohalide and subsequently freeze-drying.
Coating substrate and organohalide with an external compound. (e.g. molasses, wax, or oil)
Applying organohalide as a solid salt to substrate in dry form.
Delivery of organohalide as a non-bio-active precursor that reacts with the rumen environment to become organohalide of interest.
Manual injection of organohalide into hydrated or dehydrated substrate.

In certain embodiments, the method comprises:
a) obtaining a macroalgae substrate;
b) contacting the substrate with a fluid comprising one or more organohalides; and an edible viscous material.

In certain embodiments, the macroalgae substrate, fluid comprising one or more organohalides and viscous substrate are all combined and mixed until homogenous. In certain embodiments, any additional desired materials are added at this time.

In certain embodiments, the method further comprises lyophilizing the produced mixture until dry. In certain embodiments, the lyophilizing occurs at about −50° C. or less. In certain embodiments, the lyophilizing occurs for at least an hour, or at least 2 hours. In certain embodiments, the lyophilizing occurs for about least 2 hours.

In certain embodiments, the method comprises:
a) obtaining a macroalgae substrate;
b) contacting the macroalgae substrate with a fluid comprising bromoform; and a molasses and mixing until homogeneous;
c) lyophilizing the produced mixture.

### 6.7. Alternative Embodiments

The invention described by this patent is the final kelp product that has undergone one or more of the listed chemical processes to have a higher concentration of bromoform that matches the values of A. taxiformis or other kelp that results in a reduction of methanogenesis in rumen ruminants. The methodologies to increase the content of bromoform include: (1) using a salt form of bromoform or other small molecule, (2) adding and mixing bromoform or other chemical to the freeze-dried kelp then repackaging for consumption, (Cancho, B., Ventura, F. & Galceran, M. T. Behavior of halogenated disinfection by-products in the water treatment plant of Barcelona, Spain. Bull. Environ. Contam. Toxicol. 63, 610-617 (1999)) using a spray apparatus of a solution with bromoform or other molecule and an aqueous media such as methanol, ethanol, butanol, water, or some additional alcohol, or solvent; the media are sprayed onto the kelp in the dried form or after rehydrating the kelp, followed by refreeze drying, oven drying, or additional drying process, and packaging with or without vacuum. The algae substrates we could use could consist of a variety of types including Macrocystis pyrifera, Ascophyllum nodosum, Saccharina latissima and others. Our process may also be used to add chemicals such as halomethanes including mono-chloro and mono-bromo, dibromo and dichloro by the same methodology. This process extends to other bioactives, and alginates present in A. taxiformis and other algae with anti-methanogenic properties.

Our invention is extended to include the exclusion of algae altogether from the process, resulting in a concentrate of all stabilized, important bioactives such as bromoform. The final product can be used in feed for cows, sheep, goats, and other animals that have a rumen and/or animals that host the archaea performing methanogenesis.

### 6.7.1. Methods of Making

Purpose: Initial draft of “simplest” method for addition of liquid bromoform to kelp. Varies across steeping time and concentration of bromoform.

Completion of SOP produces a profile on the effect of lyophilization, aqueous bromoform concentration, and time spent with kelp in bromoform agitation.

### 6.7.2. Materials

TABLE 1
Reagents and Supplies
I. Reagents

| Amount | | Material | Temperature | Source |
|---|---|---|---|---|
| 20 | g | Ascophyllum nodosum | RT | North American Kelp |
| 1 | L | ddH₂O | RT | N/A |
| | | Bromoform (99%, liquid) | RT | Millipore Sigma |

II. Supplies

| Amount | Material |
|---|---|
| 8 | 2 L beaker |
| 4 | Stir plates |
| 4 | Stir bars |
| | Graduated cylinder Scale |

### 6.7.3. Experimental Procedure

I. Kelp preparation
   A. Remove dried kelp shavings from packaging.
   B. Prepare four clean, dry 2 L beakers. Label beakers by number of hours for soaking to proceed.
   C. Add 20 g of shavings and a stir bar to each 2 L beaker.
II. Bromoform preparation
   A. Prepare four clean, dry 2 L beakers. Label beakers with bromoform concentrations.
   B. To the first beaker, make a 10% (v/v) stock solution of aqueous CBrH₃.
      1. Add 900 mL of room temperature ddH₂O.
      2. Add 100 mL of room temperature bromoform (99% purity).
      3. Prepare three more concentrations of bromoform in the remaining beakers through serial dilution.
III. Addition of aqueous bromoform
   A. Decant each stock of differing bromoform concentration into a separate beaker of dried kelp, and label appropriately. The bromoform bath should cover the kelp completely and keep the kelp in suspension.
   B. Place all four beakers on separate stir plates and begin slow agitation at room temperature.
   C. Note the time or set a timer for 30 minutes.
IV. Processing materials
   A. After 30 minutes of agitation, remove beakers from stir plates and extract stir bars.
   B. Recover kelp from each beaker with tweezers and place each in a boat. Freeze dry immediately. Place one of the two samples in a lyophilizer and label with time spent in agitation and concentration of bromoform bath.
   C. Repeat procedure 1 hr, 2 hrs., 4 hrs., 6 hrs. after initial experimental setup.
   D. Process blended kelp into samples ready for GC-MS. See supplemental SOP for detail.

Purpose: Less energy intensive methodology for efficient addition of bromoform to kelp. Completion of SOP produces a characterized, dried, and homogenized sample with bromoform incorporated into a dry kelp blend.

### 6.7.4. Materials

TABLE 2
Reagents and Supplies
I. Reagents

| Amount | | Material | Temperature | Source |
|---|---|---|---|---|
| 20 | g | Ascophyllum nodosum | RT | North American |
| | | | | Kelp |
| ~20 | mL | ddH₂O | RT | N/A |
| ~20 | mL | Bromoform (99%, | RT | Millipore |
| | | liquid) | | Sigma |

II. Supplies

| Amount | Material | Material preparation |
|---|---|---|
| 1 | 1 L beaker | Cleaned and dried |
| 1 | Stir plate | N/A |
| 1 | Stir bar | N/A |
| 1 | Graduated cylinder | Cleaned and dried |
| | Lyophilizer | |
| | Pressure spray pump | |
| 1 | Laboratory tray | Cleaned and dried |
| | Scale | |
| | Fume hood | |

### 6.7.5. Procedure

I. Kelp preparation
   A. Remove dried kelp shavings from packaging.
   B. Place kelp evenly across laboratory tray
II. Bromoform preparation
   A. Prepare clean 1 L beaker with stir bar and place on a stir plate.
   B. Combine 40 mL of 1:1 ddH₂O:Bromoform solution
      1. Use graduated cylinder to measure 20 mL of ddH₂O, add to beaker.
      2. Repeat with 20 mL of bromoform.
   C. Label beakers with bromoform concentration.
III. Addition of aqueous bromoform
   A. Prepare the pump spray apparatus with diluted bromoform from previous step.
   B. In a fume hood, apply aqueous bromoform solution until kelp is dampened.
   C. Immediately place lid on laboratory tray.
   D. Allow bromoform and kelp mixture to rest for 5 minutes, then add combination to Lyophilizer.
   E. Allow to lyophilize for 24 hours.

### 6.7.6. Characterization

Technique: Gas-chromatography mass spec (GC-MS)
1. Prepare bromoform standards by serial dilution.
2. Prepare baseline non-bromoform kelp slurry standard.
3. Prepare samples for GC-MS.
   a. Sample is suspended in oil.³
      i. Mix a methanol (HPLC grade, 1 mL) with naphthalene internal standard (1 mL of 10 μg/mL). Partition for 2 h at 4 C. Extract methanol and use for GC-MS.
   b. Sample is suspended in water1
      i. Pipette off 500 μL of liquid at top of sample into Eppendorf tube.
      ii. Place 8 mL of sample into a 10 mL glass vial. Pipette 4 μL of methanol into the same vial. Cap vials with a Teflon™ septa and metallic seal. Incubate at 70° C. for 15 minutes. Gas phase is injected into GC-MS.
4. Take a GC-MS spectrum of each experimental blend, kelp slurry standard, and bromoform standard.

### 6.7.7. Characterization Protocol Extraction Methods

I. For extraction from aqueous A. taxiformis taxiformis
   A. Homogenize the Aspargopsis in vegetable oil and let steep for one day. Homogenize with IKA Ultra-Turrax® T-25, VWR, Australia. 1 mL samples were centrifuged to remove solid from aqueous samples.⁴ Analysis done according to GC-MS methods below.
II. For oil based systems and freeze-dried samples, bromoform can be extracted by mixing 1 mL subsample with 1 mL HPLC grade methanol using a napthalene internal standard (10 μg/mL) followed by partitioning for 2 h at 4° C.² Additional processing can include sonication for 15 minutes prior to transfer to GC-MS vial.

### 6.7.8. GC-MS Methods

Agilent 7890c equipped with Zebron™ ZB-wax capillary column with dimensions 30 m×0.25 m×0.25 μm were used. Pulsed injections with 1 μL, 35 psi in spitless mode with an injection port temperature of 250° C. The GC-MS interface (300° C.) was used with the oven conditions 40° C. for 1 min, ramping at 16° C./min to 250° C. and holding for two minutes with a carrier gas of Helium (2 mL/min). Sample amounts were calculated according to the ratio of peak areas of target over the ratio of the internal standard with reference to standard curves.⁵ An additional column previously reported was the Hewlett Packard (HP) 5890 series II gas chromatograph with a polyethylene glycol-coated phase on a polyimide-coated fused silica capillary column (Sol-gel wax, 30 m, 0.25 mm). Injections were 2 μL and performed in the split less mode (1.5 min) with an inlet pressure of 8 psi. The inlet liner (4 mm, 78.5×6.3 mm) was replaced after 50 samples. The injection port was held at 250° C. and the GC-MS interface at 300° C. The GC was held at 40° C. for 1 min, ramped at 16° C./min to 250° C., then held at this temperature for 2 min. Helium was used as the carrier gas. Mass spectrometry was performed on a HP 5972 Mass Selective Detector (MSD).

### 6.7.9. Brief Description of Salt-Based Bromoform Addition:

Purpose: Solid state methodology for efficient delivery of kelp with bromoform to the rumen.

Deprotonate bromoform and combine with cation to produce a bromoform-salt. For example, CBr3(−)Na(+) or K(+)

This compound exists in solid state at room temperature, and is very stable, exhibiting extremely low volatility.

This compound can then be added to dry kelp to produce a composite product that can be added to rumen feed.

When the bromoform salt reaches the rumen of the animal, because of the pH of the rumen, it becomes re-protonated, returning to its liquid form (CHBr3). This results in a final product inside the rumen of the animal that is a kelp with a liquid bromoform concentration equivalent to A. taxiformis.

### 6.8. Summary of Experimental Observations

Provision of a palatable feed supplement having higher and more consistent organohalide concentrations is essential to achieving safe, impactful, and cost-effective use of algae as a feed supplement for mitigating methane emissions or delivering other targeted benefits.

In one aspect described herein are feed supplement compositions that exhibit a higher organohalide (e.g., bromoform) concentration than natural seaweed products.

In certain embodiments, feed supplement is characterized by a lower odor or lower iodine concentrations or both than compared to natural seaweed anti-methanogenic supplements.

Algae may contain malodorous components, here called “odor triggering components.” These odor triggering components reduce the palatability of the feed that has been supplemented with compositions derived from algal biomass or alga constituents. Therefore, it is desirable to minimize the levels of these components in the final feed either by selecting an alga substrate having a reduced concentration of these components or selecting an alga substrate that has a preferred flavor and/or odor profile, and subsequently enhancing the concentration of the desired bioactive components (e.g., bromoform) in relationship to the undesired iodine or odor triggering components, thus reducing the amount of the algal based composition that needs to be added to the ruminant feed to effectively mitigate methane emissions.

There are technical challenges which exist when organohalides are administered to ruminants. These include the volatility of the organohalides, and its ability to dissolve organohalides which could be used for its delivery.

It is known that bromoform is safely and usefully degraded in anaerobic environments like livestock rumens where the enzyme methyl-coenzyme M reductase is present. As evidenced by in vitro and in vivo testing, the degradation of the bromoform component delivered by the presently provided formulations beneficially increases the propionate:acetate ratios in livestock rumens, which enables conservation of feed energy and reduction of methane emissions.

Additional in vivo testing has discovered that bromoform delivered from the provided feed supplement is degraded in livestock rumens in such a way that bromoform is not absorbed into the rumen wall, or other organs, and it is not found in metabolic byproducts produced by livestock, such as their milk, meat, or manure.

Previous trials demonstrated no residues in meat and tissue from slaughtered steers, after 48 hour with holding period (Kinley et al. Mitigating the carbon footprint and improving productivity of ruminant livestock agriculture using a red seaweed, Journal of Cleaner Production 259 (2020) 120836), and no significant increase in the level in milk (Roque et al. Inclusion of A. taxiformis, A. armata in lactating dairy cows' diet reduces enteric methane emission by over 50 percent; Journal of Cleaner Production 234 (2019) 132-138).

### 7. EXAMPLES

A feed supplement containing added bromoform provided an enhanced organohalide composition both as produced and over time under various storage conditions. through a novel steeping, coating, and freeze-drying method. The addition of a sugar sealant topcoat, such as molasses, added improved stability to the feed supplement when using the excipient binding and steeping method. The feed supplement reduced methane and increased propionate production in an in vitro setting, suggesting the supplement creates a more energetically favorable fermentation environment. The feed supplement effectively reduced or completely arrested methane production in Holstein and Jersey steers when included at 0.25%, and 0.5% dry matter intake (DMI) dosage.

### 7.1. Example 1—Preparation of Formulation 1: Kelp Comprising Enhanced Organohalide Concentrations

### 7.1.1. Proof of Concept: Coating Agent for Enhanced Bromoform Retention Through Freeze Drying

1.0 grams of Ascophyllum nodosum was placed in a beaker and coated in 1M bromoform methanol solution. The mixture was stirred gently for 8 minutes before the sample was removed from the beaker using a spatula to produce comparative Formulation A. A sample of this material was allowed to air dry to produce “Air dried Formulation A.”

1.0 grams of Ascophyllum nodosum was placed in a beaker and coated in IM bromoform methanol solution. The mixture was stirred gently for 8 minutes before the sample was removed from the beaker using a spatula. Sample was coated with minimal amount of molasses to cover kelp substrate to produce comparative Formulation B.

A sample of Formulation A and a sample of Formulation B were evenly distributed across metal trays lined with wax paper. The trays with the product and freeze dried (Harvest Right) at −50° F. F for two hours.

TABLE 3
Bromoform concentration in dry product

| | Bromoform concentration |
|---|---|
| Conditions/formulation | (w/w %) |
| Air dry Formulation A | 0.02 |
| Freeze dry Formulation A | 0.03 |
| Freeze dry Formulation B | 0.27 |

### 7.1.2. Preparation of Formulation 1

A solution of 160 mL of 1M bromoform (Sigma Aldrich) in ethanol (Millipore Siga) was prepared and combined with 906 g brown kelp (dried Ascophyllum nodosum flakes, Thorvin Kelp for Animals) 441 g of molasses (Golden Barrel, PA), and 66 g of potato starch (Bob's Red Mill) was added to a large bowl and mixed until all materials were well-combined and evenly distributed across metal trays lined with wax paper. The trays with the product were then freeze dried (Harvest Right) at −50° F. for two hours.

The freeze dried (i.e., lyophilized) product of Formulation 1 was vacuum sealed in bags or sampled directly for use in the characterization assays described below.

### 7.2. Example 2—Stability Studies

### 7.2.1. Short Term Room Temperature Stability of Bromoform in Formulation 1

To characterize the rate of change of the concentration of bromoform in materials prepared according to Formulation 1 over the course of use, samples were partitioned into each of two environments, (i) open air exposure or (ii) vacuum sealed in a bag. Both containers were maintained at room temperature (i.e., maintained to within about 68 to 77° F.). The material was sampled in triplicate over 24 hours, extracted according to the below procedure, and the concentration of bromoform was determined using gas chromatography mass spectrometry (GC-MS).

### 7.2.2. Long Term Storage Stability of Bromoform in Formulation 1

To confirm a minimum bromoform concentration in the Formulation 1 feed supplement at the time of use for the in vitro and in vivo studies below, a second sample was taken from material produced from the same production lot, vacuum sealed and stored at −20° C. for 180 days.

### 7.2.3. Sample Preparation

An aliquot (˜1 g) of product was weighed and placed in a sample tube. A 10 μg/mL internal standard solution of naphthalene in methanol (Millipore Siga) was added to the sample tube. The tube with the stock solution and product is sonicated in a water bath for 3 minutes. The liquid was removed from the sample tube and placed in a 10 mL plastic syringe barrel and fitted with a 0.22 μM nylon filter. Each sample was pressed through the filter into a clean glass GC-MS vial.

### 7.2.4. Instrument Protocol

Agilent 7890c equipped with Zebron™ ZB-wax capillary column with dimensions 30 m×0.25 m×0.25 um was used. Pulsed injections with 1 μL, 35 psi in spitless mode with an injection port temperature of 250° C. The GC-MS interface (300° C.) was used with the oven conditions 40° C. for 1 min, ramping at 16° C./min to 250° C. and holding for two minutes with a carrier gas of Helium (2 mL/min). Sample amounts were calculated according to the ratio of peak areas of target over the ratio of the internal standard with reference to standard curves. An additional column previously reported was the Hewlett Packard (HP) 5890 series II gas chromatograph with a polyethylene glycol-coated phase on a polyimide-coated fused silica capillary column (Sol-gel wax, 30 m, 0.25 mm). Injections were 2 μL and performed in the splitless mode (1.5 min) with an inlet pressure of 8 psi. The inlet liner (4 mm, 78.5×6.3 mm) was replaced after 50 samples. The injection port was held at 250° C. and the GC-MS interface at 300° C. The GC was held at 40° C. for 1 min, ramped at 16° C./min to 250° C., then held at this temperature for 2 min. Helium was used as the carrier gas. Mass spectrometry was performed on a HP 5972 Mass Selective Detector (MSD).

### 7.2.5. Results

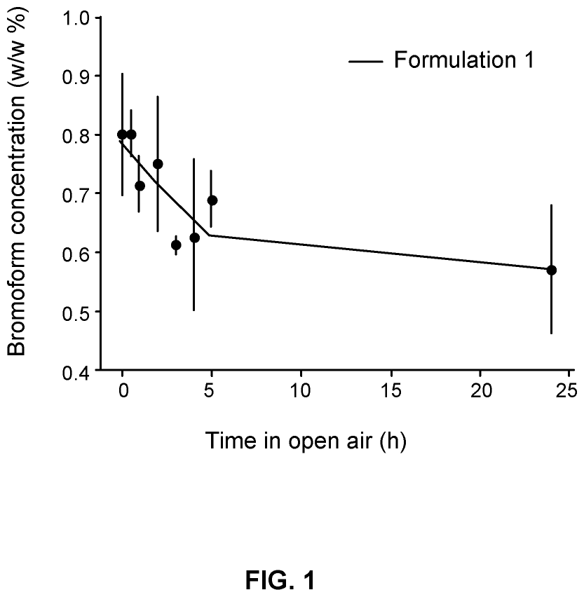

TABLE 4
Short Term Stability Study (Data plotted in FIG. 1)

| | | Bromoform | |
|---|---|---|---|
| | | concentration | SD |
| Sample conditions | Time (h) | (w/w %) | (w/w %) |
| open air, room temp | 0 | 0.80 | 0.105 |
| open air, room temp | 0.5 | 0.80 | 0.041 |
| open air, room temp | 1 | 0.71 | 0.048 |
| open air, room temp | 2 | 0.75 | 0.115 |
| open air, room temp | 3 | 0.61 | 0.014 |
| open air, room temp | 4 | 0.63 | 0.133 |
| open air, room temp | 5 | 0.69 | 0.051 |
| open air, room temp | 24 | 0.57 | 0.107 |
| Sealed | 5 | 0.90 | 0.410 |
| Sealed | 24 | 0.48 | 0.180 |

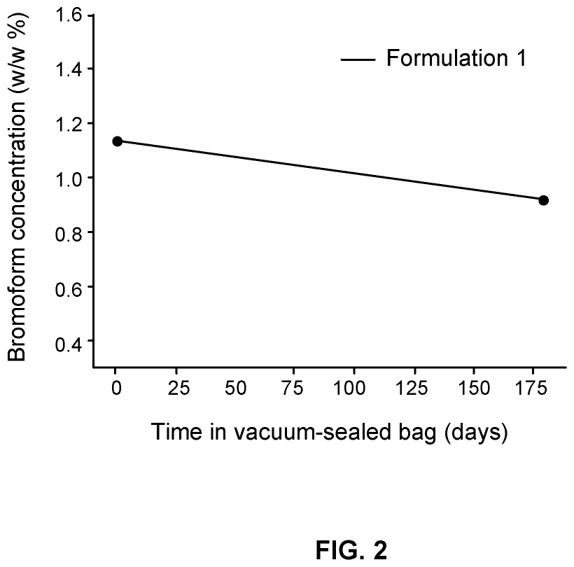

Table 5 and FIG. 2 show the results of long term storage stability studies when vacuum sealed, at −20° C.

TABLE 5
Long Term Storage Stability Study

| | | Bromoform |
|---|---|---|
| | Time | concentration |
| Sample conditions | (days) | (w/w %) |
| vacuum sealed, frozen | 0 | 1.13 |
| vacuum sealed, frozen | 180 | 0.92 |

### 7.2.6. Conclusions

Proof of concept studies showed that addition of a coating agent reduced bromoform loss after freeze drying compared to the same formulation without the coating agent.

Short term stabilization studies showed that a feed supplement of Formulation 1 provide at least 0.70% wt/wt bromoform to the ruminant assuming the supplement started with at least about 0.8% wt/wt bromine and is consumed within about 5 hours in open air with ambient temperature generally around room temperature. We would expect a feed supplement prepared with a higher starting bromine concentration to provide a higher dosage at the time of ingestion.

Long term stabilization studies confirmed that storage in vacuum sealed packaging and maintained in a freezer (−20° C.) up to 180 days provided a baseline of at least 0.92% wt/wt bromine in Formula 1 at the time it is opened from storage. This is down from 1.3% wt/wt measured at time of production.

### 7.3. Example 3—In Vitro Fermentation Studies Confirm Formulation 1 Significantly Reduces Methane Production

### 7.3.1. Fermentation Study Protocol

### Formulation 1—Control, Low Dose and High Dose

The material of Formulation 1 was received vacuum packed and was stored frozen (−20° C.) until use. Once thawed, material was kept in airtight containers. The material was used for this study between 6 and 12 days after production. Three test solutions were prepared corresponding to 0, 1.0 and 2.0 mg product per mL methanol referred to herein as “control,” “low dose,” and “high dose”). These test solutions approximate the supplementation of Formulation 1 at 0%, 0.25% (low dose), or 0.50% (high dose) by dry weight, respectively.

To make the low dose and high dose test solutions, 1.0 g and 2.0 g of Formulation 1, were placed in a 100 mL volumetric flask, and 100 mL of HPLC grade methanol was added to each volumetric flask. The flasks were placed into a sonication bath and sonicated for three minutes. Each Formulation 1 test solution (100 μL) was added to the in vitro fermentations described below.

### 7.3.1.1 Ruminant Feeding—Diet A (Majority Corn) Diet B (Majority Alfalfa).

Three ruminally cannulated Holstein steers (250-350 kg BW) were used as a source of ruminal contents. Prior to enrollment in this study, the steers were fed a forage diet (alfalfa cubes) at 1.75×Net energy for maintenance (NEm) for a duration of 21 days prior to harvesting ruminal contents for use in the present study. The steers received their daily ration in a single portion at 07:00 daily.

### 7.3.1.2 Fermentation Experiments

Approximately 2 kg of ruminal contents were collected from each animal, processed with a blender under a CO₂ head space, and strained through 4 layers of cheesecloth. Ruminal contents were then combined to produce about 3300 mL of a pooled inoculum source per diet for use in the fermentation experiments.

Buffer solution, macro- and micro-mineral solutions, and reducing solution were prepared as described by Goering and Van Soest (1970) and combined. 99 mL of the resulting ruminal inoculum was added to each of six 260 mL fermentation vessels. 0.4 g of alfalfa and corn substrate corresponding to Diet A (pre-weighed and pre-wetted with 1 ml water) was added to each of three fermentation vessels, and 0.4 g of a substrate corresponding to Diet B (pre-weighed and pre=wetted with 1 mL water) was added to each of three fermentation vessels.

One test solution was added to each the six fermentation vessels in accordance with the 2×3 factorial design (2 diet, 3 supplement) of the in vitro fermentation protocol. 100 ml of one of the Formulation 1 “kelp extract” or “KE” test solutions (control 0%, low dose 0.25% or high dose 0.50%) was added to one of each of the three reaction flasks comprising Diet A ruminal inoculum and to each one of the three reaction flasks comprising Diet B ruminal inoculum to produce the six distinct treatments tabulated below:

TABLE 6
Six treatments evaluated in fermentation
experiments - 2 × 3 factorial design

| Diet A (majority corn)/Control | Diet B (majority alfalfa)/Control |
|---|---|
| Diet A/High Dose | Diet B/High Dose |
| (0.50% by weight) | (0.50% by weight) |
| Diet A/Low Dose | Diet B/Low Dose |
| (0.25% by weight) | (0.25% by weight) |

The vessels were then purged with CO₂ and fitted with automatic pressure transducers and a gas sampling port (Ankom Technology, Macedon, NY). Each vessel was pre-calibrated using water displacement to determine the total volume for gas production.

The in vitro fermentation study consisted of the above six treatments, replicated four times daily (24 batch culture vessels) over the course of three consecutive days (72 total batch culture vessels). Fresh ruminal contents were harvested every 24 hours.

### 7.3.1.3 Determining Gas Production

For each fermentation culture vessel, gas production was monitored at 5 minute intervals throughout a 48-h fermentation period using an automated pressure transducer system (Ankom Technology, Macedon, NY). At the completion of the 48-h fermentation, vessels were placed into an ice bath while gas samples were drawn into evacuated test tubes. Gas samples were analyzed for VFA and methane concentration using gas chromatography. Flasks were then opened, pH measured, and an 8-mL aliquot of the fermentation media were combined with 2 mL of 25% metaphosphoric acid for subsequent analyses. These samples were centrifuged at 39,000×g, transferred to vials, and adapted to a micro-plate (ThermoFisher Scientific Inc., Beverly, MA). The potential extent and rate of gas production in response to diet substrate degradation were determined using the one-pool exponential model (3): P=b(1−e^{-k(t-l)}) where P is the cumulative pressure (psi), b is the maximum pressure (psi), k is the rate of pressure (h−l), t is the time (h), and l is a discrete time lag prior to the start of fermentation (h). Gas production data were fitted to the above nonlinear model using GraphPad Prism 6 (GraphPad Software, Inc., La Jolla, CA, USA). In this model, it is assumed that no pressure is produced until the discrete time lag has elapsed. Gas production is then calculated from the vessel pressure corrected from current atmospheric pressure into standard atmospheric pressure (101.325 kPa). This approach yields total gas production and methane production values through gas chromatography analysis.

Gas evolved from the in vitro system was measured for concentration of VFAs, specifically acetate, propionate, isobutyrate, butyrate, isovalerate, and valerate through gas chromatography (GC). Propionate proportion is determined by calculating the fraction of propionate concentration present in the GC analysis as compared to the collective concentration of all VFAs analyzed as listed above.

### 7.3.2. Results

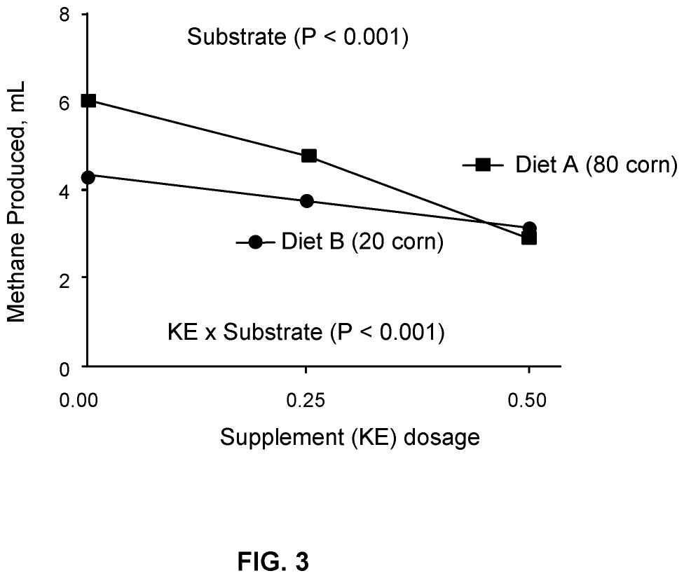

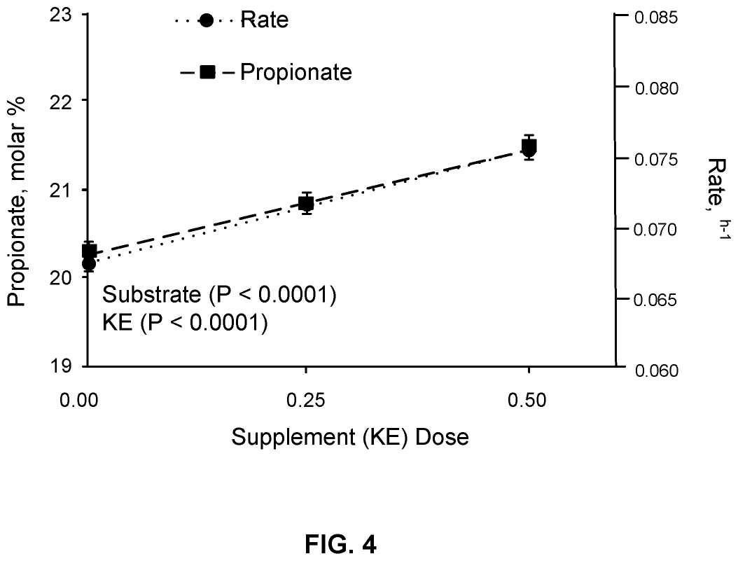

FIG. 3 illustrates the dose dependent decrease in methane produced in both the Diet A and Diet B supplemented cattle. Table 7 and FIG. 4 show the impact of Formula 1 on rate of gas produced and propionate proportion.

TABLE 7
Impact of Formula 1 on rate of gas produced and propionate

| | Propionate proportion, | Rate of gas, |
|---|---|---|
| | molar %. (Diet A | h⁻¹ (Diet A |
| Formula 1 | and Diet B avg.) | and Diet B avg.) |
| Control (Solvent alone) | 20.31 | 0.067 |
| Low Dose (0.25%) | 20.86 | 0.072 |
| High Dose (0.5%) | 21.47 | 0.076 |

### 7.3.3. Conclusions

The Formula 1 supplementation provides a dose correlated reduction in methane across both the low (0.25%) and high (0.5%) dose for both Diet A and Diet B.

Formula 1 supplementation has a dose correlated increase in the proportion of propionate in the total evolved gases. This data indicates that Formula 1 supports a more energetically favorable fermentation that leads to improved feed efficiency in supplemented ruminants.

### 7.4. Example 4—In Vivo Reduced Enteric Methane—Holstein Steers Administration of Formulation 1

### 7.4.1. Protocol

### 7.4.1.1 Holstein Steer Management.

Twelve Holstein steers (160.5±8.54 kg BW) were used in a 14-d randomized complete block design experiment to confirm the hypothesis that the feed supplement of Formulation 1 (also referred to as “kelp” in this study) reduces enteric methane production. Prior to initiation of the experiment, all steers were vaccinated and backgrounded on a corn-silage based diet for a minimum of 14 d. Steers were housed indoors at thermo-neutral conditions (22° C.) in individual 3 m×3 m pens with ad libitum access to water. A 14 h: 10 h, light:dark cycle was established with lights turning on at 0600 h and off at 2000 h each day. For measures of methane production, steers were moved within the same facility to metabolism stalls (1.25 m×2 m) fitted with indirect calorimetry headboxes (see below) for 72 h of continuous measures of gas production. Animals were limit-fed a corn silage-based diet at 1.5 times the net energy requirements for maintenance of growing steers.

### 7.4.1.2 Experimental Design and Procedures.

Holstein steers were blocked (n=4 per block) by weight and randomly assigned to one of two treatments (n=2 per treatment within each block). Dietary treatments consisted of a corn silage-based diet supplemented with either a ground corn carrier (control) or ground corn carrier plus kelp (i.e., Formulation 1) (10% of carrier). Formulation 1 was included in the supplement at a rate to supply 0.5% of the total ration dry matter.

### 7.4.1.3 Preparation of Pre-Mix

The supplement pre-mix to be added to the feed was prepared by mixing the supplement of Formulation 1 with ground corn carrier in a commercial stainless steel chopper (Mandeville Company, Inc., Minneapolis, MN, USA) for 10 minutes followed by 10 seconds of pulse-blending (Waring MX1000XTX Extreme, Waring Commercial, McConnellsburg, PA, USA). Observationally, this premixing procedure produced a uniform distribution of Formulation 1 (“kelp”) material throughout the supplement. The control supplement (ground corn only) was subjected to the same procedures to equalize potential changes in particle size. Premixed supplements were prepared for each block and stored in sealed containers at 5° C. until fed. Each premixed supplement was added to the corn-silage based ration as a top-dress and hand mixed in the feed bunk.

### 7.4.1.3.1 Sample Collection and Evaluation

The basal diet was subsampled daily and composited weekly for dry matter analysis (55° C., air-forced oven). Similarly, any feed refusals were weighed, sampled, dried, and included in the calculation of dry matter intake. Enteric methane production, along with carbon dioxide production and oxygen consumption, was measured by confining the animals in metabolism stalls fitted with stainless steel headboxes. The headboxes and respiratory gas measurement system has been previously described by Koontz et al. (2010). Briefly, each headbox is fitted with an air conditioning unit (humidity and temperature control), a stainless steel feed bunk, and a continuously supplied water basin. Animals are tethered inside the headbox through an opening encased with a canvas shroud that is secured around the animal's neck. Collection and analysis of respired gasses was made by a semi-continuous automated process. Airflow through the headbox was set at 300 liters per minute to maintain a carbon dioxide concentration of between 0.4 to 0.7% of the exhaust air. Daily respiratory gas production or consumption was calculated as the sum over a 24 h period and averaged over the 72 h period.

### 7.4.1.3.2 Statistical Analysis.

Data were analyzed as a randomized complete block design using the GLM procedure of SAS (9.4, Cary, NC, USA). Treatment and block were included as fixed variables. Oxygen consumption and carbon dioxide and methane production were totaled over each 24 h period and averages for each animal included as the dependent variables. Because methane concentrations in expired air were below detection in the Formula 1 treatment group, maximum methane production was estimated for this group using the lowest measured methane concentration (2 ppm) in the exhaust air of control animals. A common variance, i.e. that observed for the control treatment, was used across treatments for statistical analysis. This method was chosen because it is highly conservative in terms for reducing type 1 error. Dry matter intake was analyzed separately as intake during the treatment adaptation period and during gas collection. One steer assigned to the Formula 1 treatment group became ill and had low dry matter intake throughout the entire study, and thus removed from all analyses. Based on subsequent observations and death two-weeks after the experiment, the illness appeared to be unrelated to the experimental treatment. Significance was set at P≤0.05.

### 7.4.1.4 Results.

TABLE 8
Effects of dietary treatment of Formulation 1 (“Kelp”) on
dry matter intake of Holstein steers during dietary
adaptation and measurements of respiratory gases.

| | Control | Kelp | SE^{a} | Block | Trt |
|---|---|---|---|---|---|
| Dry matter intake (kg) | | | | | |
| Diet Adaptation | 3.39 | 3.34 | 0.027 | <0.01 | 0.20 |
| Gas Collection | 3.35 | 3.21 | 0.045 | <0.01 | 0.04 |
| Dry matter intake (kg/kg BW) | | | | | |
| Diet Adaptation | 0.021 | 0.021 | 0.0002 | 0.10 | 0.17 |
| Gas Collection | 0.021 | 0.020 | 0.0021 | 0.51 | 0.11 |

^{a}Data are presented as least square means ± the standard error of the mean; n = 6 and n = 5 for the control and kelp supplanted treatment, respectively.

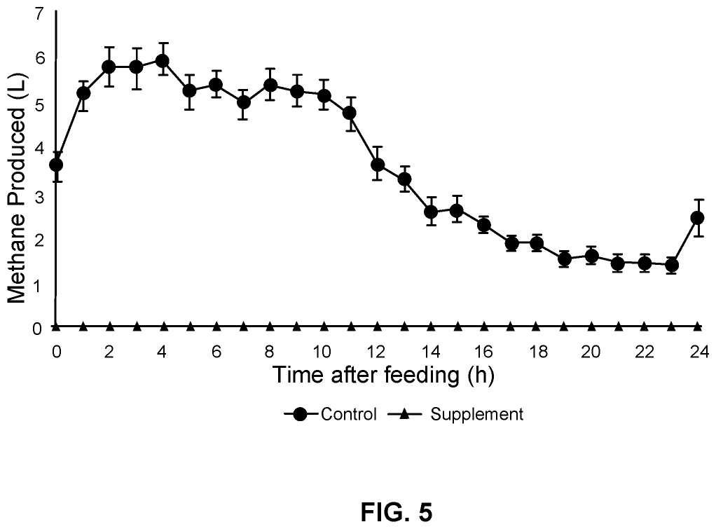

Methane concentration in exhaust air, and thus production, was below detectable limits for all time points in steers supplemented with Formulation 1, as illustrated in FIG. 5.

TABLE 9
Summary of results

| Dose | grams supplement | | | % Methane | (% Methane |
|---|---|---|---|---|---|
| Supplement | per day | Methane | Methane | reduced | reduced)/ |
| (w/w %) | (g/day) | (L/day) | (L/kg DMI) | (g/lb DMI) | (g supplement) |
| Control | 0 | 88.7 | 26.48 | | |
| 0.5 | 16.05 | <2.2 | 0.685 | 97.411 | 6.069 |

### 7.4.1.5 Conclusion.

Profound methane reduction to below detection limits, (less than 2.2 L/day) was observed with administration of Formulation 1 to Holstein steers at 0.5% of the total ration dry matter.

### 7.5. Example 5—In vivo Reduced Enteric Methane—Jersey Cows Administration of Formulation 1

### 7.5.1. Protocol

### 7.5.1.1 Jersey Cow Management

Twelve Jersey cows (about 500 kg BW) were used for this experiment and were already halter broke and trained to the use of metabolism stalls and headboxes. Animal handling and space for this experiment are in accordance with the Guide for the Care and Use of Agricultural Animals in Agricultural Research and Teaching (FASS, First Revised Edition, January 1999).

### 7.5.1.2 Experiment Design and Procedures

The experiment was conducted with 12 animals and 3 treatments. Treatments included a control diet with no supplement of Formulation 1 and two supplement levels of Formulation 1 (0.40 and 0.60% of total ration dry matter, low dose, and high dose, respectively). Animals were paired by similar body weight and assigned randomly within pair to treatment for 21-d periods. A 3 week adaptation period was used to acclimate cattle to the finishing diet before starting the experiment. The experimental design was a replicated 3 period Latin square, with 4 squares and 3 cows per square. Each cow received each treatment, in subsequent periods, with all treatments represented in each period. This provided 12 observations per treatment.

Periods consisted of adaptation to diet (d 1-15), total fecal collection (d 16-19), and two, 23-h periods in the headbox calorimeter. A one-day 23-hr measurement is the standard (Morris, 2020), but given the importance of methane measures to the experiment, this was doubled to ensure accurate and repeatable results. Measurements included dry matter intake, digestible energy of the diet, and total tract digestion of dry matter, organic matter, and neutral detergent fiber. Digestibility parameters were calculated using total fecal collection with zeolite clay as an external marker for acid insoluble ash.

### 7.5.1.3 Sample Collection and Evaluation

Methane production was measured from individual animals using headboxes in which total gas flow is measured and a constant sample of inlet and exhaust air is sampled. These samples were then analyzed for CH4 using a gas chromatograph. Animals were weighed at the conclusion of each period to monitor for any adverse effects due to treatment on weight gain.

### 7.5.1.4 Diets and Feeding.

The supplement of Formulation 1 was included in the diet as a top dress, targeting a set 0 g, 69, or 103 g per day for each cow, see table below. The amount provided was determined by active ingredient concentration in the final product. All diets contained dry meal supplement. The primary components in the meal supplement are calcium, trace mineral premix and vitamin ADE premix. The carrier for the meal supplement was finely ground corn. Diets were formulated to provide sufficient Ca and Ca:P ratios. Cows were fed once daily. The diet consisted of 20% corn silage, 20% distillers grains plus solubles, 4% supplement, and 56% dry-rolled corn.

### 7.5.3. Conclusions

Substantial methane reduction was observed, greater than 60%, with administration of Formulation I to Jersey steers at 0.6% of the total ration dry matter.

### 7.5.4. Results

TABLE 10
Effect of Formulation 1 supplementation
on greenhouse gas emissions.

| | Treatment [symbol] | | | | |
|---|---|---|---|---|---|
| | Control | 0.4% | 0.6% | SEM | P-value |
| CH₄, g/day | 164.9 [symbol] | 88.2 [symbol] | 44.4 [symbol] | 15.6 | <0.01 |
| CH₄, g/lb of DMI | 7.94 [symbol] | 4.84 [symbol] | 2.91 [symbol] | 0.8 | <0.01 |
| CO₂, g/day | 842.0 [symbol] | 7844 [symbol] | 7728 [symbol] | 424.1 [symbol] | 0.08 |
| CO₂, g/lb of DMI | 407.6 | 416.6 | 428.4 | 20.4 | 0.39 |
| O₂ consumption, | 5729 | 5065 | 5430 | 362.4 | 0.26 |
| g/day | | | | | |
| O₂ consumption | 281.8 | 265.2 | 296.5 | 22.6 | 0.39 |
| g/lb of DMI | | | | | |
| RQ [symbol] | 1.04 | 1.02 | 1.02 | 0.02 | 0.32 |

[symbol]

All treatments received the same basal diet with the addition of algae as a top dress (0, 69, or 103 g/d) mixed with modified distillers grains plus solubles at 1 lb DM/cow daily. The algae inclusion was approximately 0.4 and 0.6% of diet DM.
RQ = respiratory quotient, Liters per day of CO₂ production/Liters per day of O₂ consumption
Means in row with unique superscripts are different (P ≤ 0.05) [symbol]
indicates data missing or illegible when filed

TABLE 11
Effect of Formulation 1 supplementation on cattle
performance, intake, digestibility, and energy.

| | Treatment | | | | |
|---|---|---|---|---|---|
| | Control | 0.4% | 0.6% | SEM | P-value |
| Performance | | | | | |
| BW, lb | 1086 | 1077 | 1081 | 42.1 | 0.66 |
| BCS [symbol] | 3.9 | 3.8 | 3.8 | 0.2 | 0.32 |
| Intake and Digestability | | | | | |
| DM | | | | | |
| Intake, lb/d | 21.4 [symbol] | 19.2 [symbol] | 18.5 [symbol] | 1.4 | 0.01 |
| Digestibility | 70.6 | 68.9 | 68.6 | 2.4 | 0.51 |
| OM | | | | | |
| Intake, lb/d | 20.5 [symbol] | 18.3 [symbol] | 17.9 [symbol] | 1.4 | 0.01 |
| Digestibility, % | 75.2 | 74.7 | 74.7 | 1.8 | 0.89 |
| Energy | | | | | |
| Gross Energy, | 1.99 | 2.00 | 1.99 | 0.01 | 0.44 |
| Mcal/lb | | | | | |
| Digestible Energy, | 1.44 | 1.42 | 1.43 | 0.03 | 0.67 |
| Mcal/lb | | | | | |
| DE/GE | 0.72 | 0.71 | 0.73 | 0.02 | 0.66 |

[symbol]

All treatments received the same basal diet with the addition of algae as a top dress (0, 69, or 103 g/d) mixed with modified distillers grains [symbol] solubles at 1 lb DM/cow daily. The algae inclusion was approximately 0.4 and 0.6% of diet DM. [symbol]
Body Condition Score was performed axing a 5-point scale common in the dairy industry. [symbol]
Means in row with unique superscripts are different (P ≤ 0.05) [symbol]
indicates data missing or illegible when filed

TABLE 12
Observed methane reduction for low dose
and high dose Formula 1 supplementation

| Dose | grams supplement | | | % Methane | (% Methane |
|---|---|---|---|---|---|
| Supplement | per day | Methane | Methane | reduced | reduced)/ |
| (w/w %) | (g/day) | (g/day) | (g/lb DMI) | (g/lb DMI) | (g additive) |
| Control | 0 | 164.9 | 7.94 | NA | NA |
| 0.4 | 69 | 88.2 | 4.84 | 39 | 56.58 |
| 0.6 | 103 | 44.4 | 2.91 | 63 | 61.50 |

### 7.6. Summary of Examples and Conclusions

Coating the organohalide infused kelp substrate with viscous edible coating, e.g., molasses unexpectedly significantly reduced the rate of bromine loss over time, i.e., increased the short and long-term stability of the product, enabling the provision of feed supplements with high initial bromine concentrations, e.g., greater than 0.8% wt/wt that remained high at the time of ingestion by the animals (within 24 hours), in both long term storage conditions as well as in short term conditions once the supplement is top dressed on the animal feed.

Administration of a supplement of Formulation 1 to Holstein steers yields extraordinary methane reductions of greater than 97% in vivo at the 0.5% DMI dosage and a significant 63% reduction in methane was observed at the 0.6% dosage in Jersey cows.

Administration of a supplement of Formulation 1 also increases the propionate:acetate ratio in vitro at both 0.25 and 0.5% DMI dosage. This change in the propionate:acetate ratio suggests the rumen fermentation process is more energetically favorable and provides an enhanced feed efficiency upon feed supplementation with Formulation 1.

TABLE 13
Summary of in vivo trial results with administration of Formulation 1.

| | Formulation 1 | | | | | |
|---|---|---|---|---|---|---|
| | wt/wt % | | | | | |
| | bromoform/ | | | | | |
| | total dry | Formulation 1 | | | | |
| | weight - | dosage | | Observed | | |
| | evaluated at | (g/kg, additive/ | Formulation 1 | Methane | | |
| | production | body weight) | % of DMI | reductions | Animals | Diet |
| Example 1 | 1.034 | ~0.10 | 0.5% | 97% | Holstein | Corn-sileage, |
| subsection | | | | | steers | Distillers |
| 6.1.5 | | | | | 160.5 +/− | grains |
| | | | | | 8.54 kg BW | |
| Example 1 | 1.034 | ~0.14 | 0.4% | 39% | Jersey | Rolled-corn, |
| subsection | | | | | cows ~500 | corn sileage, |
| 6.1.5 | | | | | kg BW | Distillers |
| | | | | | | grains |
| Example 1 | 1.034 | ~0.21 | 0.6% | 63% | Jersey | Rolled-corn, |
| subsection | | | | | cows ~500 | corn sileage, |
| 6.1. | | | | | kg BW | Distillers |
| | | | | | | grains |

### 8. EQUIVALENTS AND INCORPORATION BY REFERENCE

While the invention has been particularly shown and described with reference to a preferred embodiment and various alternate embodiments, it will be understood by persons skilled in the relevant art that various changes in form and details can be made therein without departing from the spirit and scope of the invention.

References, issued patents and patent applications cited within the body of the instant specification are hereby incorporated by reference in their entirety, for all purposes.

What is claimed is:

1. A composition comprising: at least one exogenous organohalide and a macroalgae substrate, wherein the at least one organohalide compound is not derived from a macroalgae.

2. The composition of claim 1, further comprising a viscous edible coating.

3. The composition according to any preceding claim, further comprising a viscous edible coating in an amount from about 15-55% by weight of the composition.

4. The composition according to claim 3, wherein the viscous edible coating is molasses.

5. The composition of claim 1, wherein the at least one exogenous organohalide is selected from a compound of Formula I, Formula II and Formula III or a salt thereof: 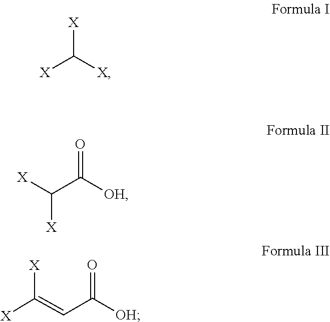
wherein X is a halogen selected from Br, I, and Cl, or H; and
wherein the compound of Formula I, Formula II and Formula III comprises at least one halogen.

6. The composition of claim 5, wherein the at least one exogenous organohalide is bromoform.

7. The composition of claim 1, wherein the at least one exogenous organohalide is present in an amount of about 0.8% by dry weight of the composition or more.

8. The composition of claim 1, wherein the macroalgae substrate is characterized by an amount of bromoform in an amount of 0.5% by dry weight or less.

9. The composition of claim 1, wherein an amount of organohalide present after storage under vacuum for 65 weeks at 25° C. is at least 80% of a starting concentration.

10. The composition of claim 6, comprising 0.5 to 1.5% bromoform by dry weight and wherein administration in a range from 0.4 to 0.6 wt/wt of feed supplement to total dry matter intake results in 50%-100% methane reduction compared to an unsupplemented animal.

11. Use of the composition of claim 1 to reduce enteric methane emissions, wherein the composition is administered to a ruminant animal.

12. Use of the composition of claim 11, wherein the composition is administered at 0.3 to 1.0% total dry matter intake.

13. A non-therapeutic method for reducing total gas production and/or methane production in ruminant animals said method comprising:
administering to a ruminant animal, an effective amount of a feed supplement comprising the composition of claim 1.

14. The method of claim 13, wherein the composition is administered at a rate of 0.3 to 1.0% total dry matter intake.

15. Use of the composition of claim 1 to supplement a diet of a ruminant animal with bromoform, wherein the ruminant animal is administered an effective amount of the composition.

16. A method of making a ruminant feed supplement, the method comprising:
(a) obtaining a substrate; and
(b) contacting the substrate with a fluid comprising one or more organohalides and a viscous edible coating.

17. The method according to claim 16, wherein the method further comprises lyophilizing the ruminant feed supplement until dry.

18. The method according to claim 17, wherein:
(a) the lyophilizing is carried out at about −50° C. or less; and/or
(b) the lyophilizing is carried out for at least 1 hour or at least 2 hours.
